(19) United States
(12) Patent Application Publication
(10) Pub. No.: US 2025/0051042 A1
(43) Pub. Date: Feb. 13, 2025

(54) SYSTEMS, METHODS, AND DEVICES FOR ROBOTIC CAPTURE OF A FREE FLYER OR OTHER UNSUPPORTED OBJECT

(71) Applicant: MacDonald, Dettwiler and Associates Inc., Brampton (CA)

(72) Inventors: Tej Singh Sachdev, Milton (CA); Philip Raymond Apperly, Tottenham (CA); Steve Fisher, Schomberg (CA); Charles Cass, Acton (CA)

(21) Appl. No.: 18/721,813

(22) PCT Filed: Dec. 23, 2022
(86) PCT No.: PCT/CA2022/051895

§ 371 Date: Jun. 19, 2024

Related U.S. Application Data
(60) Provisional application No. 63/293,216, filed on Dec. 23, 2021.

(51) Int. Cl. B64G 1/64; B25J 11/00; B25J 15/00

(52) U.S. Cl. CPC B64G 1/6462; B25J 11/00; B25J 15/0052

(57) ABSTRACT

Systems, methods, and devices for robotic capture of an object are provided. A system for robotic-based capture of a free flyer object includes a grapple fixture for mounting to the free flyer object and an end effector for capturing the free flyer object by interfacing with the grapple fixture. The grapple fixture includes a base and a deflectable probe. The end effector includes a probe guiding surface for deflecting and guiding a probe tip of the probe through an opening in the probe guiding surface and into a grappling position. The end effector includes a probe sensing element for sensing when the probe tip is in the grappling position and triggering a capture mechanism. The capture mechanism grapples the probe tip and an actuator retracts the capture mechanism to a predetermined position to establish a load-bearing interface between the free flyer object and the end effector.

### TECHNICAL FIELD

The following relates generally to robotic systems and devices, and more particularly to a robotic device for capturing a free flying object or other unsupported objects.

### INTRODUCTION

The behaviour of free flying objects presents various challenges for capture by a robotic system. Such systems are desirable particularly in environments where humans may not be able to operate or service machinery, such as underwater or in space.

Traditional approaches may require precise engagement or first contact of a grapple fixture and an end effector to capture and handle a free flying object. Free-flying objects may be in ‘free-drift’ where the rate of change of position and orientation in any direction is non-zero. In some cases the free-flyer in ‘free-drift’ may have significant angular rotation rates and is then considered to be ‘tumbling’. Alternatively, free-flying objects may have their own attitude and/or reaction control systems, and may change linear and angular rates autonomously, or not act like a passive inertial mass.

A robotic capture system will use a set or sets of sensors to ascertain the relative position and orientation of the free-flyer and its relative linear and angular drift rates, then compute the trajectory required for capture. Any inaccuracies in this system will result in misalignments between the end-effector (robotic capture system) and the grapple fixture (mounted on the free-flyer). Misalignment of the end effector and the grapple fixture probe may prevent the robotic capture device from successful engagement or first contact with the probe, thereby failing to capture the free flyer object and preventing the ability to maneuver or manipulate the free flyer object (or components thereon).

If, during a capture attempt, there is contact between the End-Effector and Grapple Fixture where the misalignments are large enough that a successful physical connection is not made (i.e., contact occurs outside of the ‘capture-envelope’ of the devices) then the free-flyer would be pushed away, rather than captured. The contact forces will cause the free-flyer drift rates to change due to this contact. In some cases, this may cause a freely drifting free-flyer to drift at increased rates that make a subsequent recapture attempt not possible. Or the rate control capabilities of an actively controlled free-flyer may be overwhelmed by the imparted contact energy and the free-flyer is no longer able to control its position and orientation. The contact forces of a failed capture, due to the misalignments, may cause irreparable damage to the free-flyer. It is thus critical that the end-effector and grapple fixture system provide a robust capture reliability, with a sufficient ‘capture-envelope’ that exceeds the possible misalignments at contact.

The movement of the object to be captured can present challenges in aligning, soft-capturing, and then rigidizing to establish a load-bearing interface between the captured object and the end effector. This can apply to a free flying scenario or other scenario in which the movement of the object to be captured is less predictable.

Accordingly, there is a need for improved systems, methods, and devices for capturing and manipulating a free flying object that overcome at least some of the disadvantages of existing systems and methods.

### SUMMARY

A system for robotic capture of a free flyer object is provided. The system includes a grapple fixture for mounting to the free flyer object and an end effector that interfaces with the grapple fixture to capture the free flyer object. The grapple fixture includes a base having a mounting surface for mounting to the free flyer object and a mating surface opposing the mounting surface for mating with the end effector and a deflectable probe connected to the base via a deflectable joint for enabling deflection of the deflectable probe. The deflectable probe includes a probe tip to enable grappling. The end effector includes: an interface for connecting to and enabling manipulation by a robotic arm (“robotic arm interface”) or connection to a spacecraft with the capability to enable direct capture; a probe guiding surface for deflecting and guiding the probe tip of the deflectable probe towards and through an opening in the probe guiding surface and into a grappling position as the end effector is moved towards the grapple fixture and the grapple fixture is within a capture envelope of the end effector; a capture mechanism (or “grapple”) configured to grapple the probe tip when triggered by the presence of the probe tip (thus entering a state known as ‘soft-capture’, where there is an inseparable connection that constrains some but not all degrees of freedom); a capture mechanism triggered sensing element for sensing when the probe tip is in the grappling position and has triggered the capture mechanism; and an actuator configured to retract the capture mechanism along a capture axis to a predetermined position at which the mating surface of the base of the grapple fixture is preloaded against the probe guiding surface to establish a load-bearing interface between the free flyer object and the end effector (known as ‘hard-capture’).

The deflectable joint may further include a cushioning spring for cushioning an initial contact of the probe tip with the probe guiding surface.

The deflectable joint may be a spring-centered spherical joint.

The system may further include the robotic arm and a robotic arm controller for controlling the robotic arm, wherein the robotic arm controller is configured to command the robotic arm to move the end effector towards the grapple fixture upon approach such that the relative velocity of the end effector and the free flyer object is maintained within a predetermined velocity band known to promote successful soft capture.

The mating surface of the grapple fixture may include a first alignment component and the probe guiding surface may include a second alignment component, wherein the first and second alignment components are configured to mate with each other for aligning the connection between the grapple fixture and the probe guiding surface of the end effector.

The second alignment component may be a raised annulus and the first alignment component may be a recessed annulus.

The first alignment component may include a plurality of recesses in the mating surface and the second alignment component may include a plurality of protrusions, wherein each respective one of the plurality of protrusions is configured to mate with a respective one of the plurality of recesses.

Each of the plurality of recesses may include a bottom surface and a plurality of angled or curved side alignment surfaces and each of the plurality of protrusions (e.g., ‘fins’) may include a rounded surface profile to promote sliding of the protrusions onto the bottom surface when the protrusions contact one of the plurality of side alignment surfaces, thus bringing the interface into fully constrained alignment at ‘hard-capture’.

The capture mechanism may constrain linear motion of the free flyer object via the grappling of the probe tip. Grappling of the probe tip by the capture mechanism may constrain the center of the probe tip in x/y/z but allow motion of the grapple fixture (and free-flyer) relative to the constraint point.

Angular and lateral offsets of the free flyer object relative to the end effector may be removed by retracting the capture mechanism and bringing the grapple fixture body into mate with the alignment surface on the end effector. In doing so, angular motion is constrained.

The capture mechanism may be configured to constrain linear motion at soft-capture and constrain all degrees of freedom (“DOFs”) at hard-capture.

A robotic end effector for capturing a free flyer object via a grapple fixture mounted to the free flyer object is provided. The end effector includes a robotic arm interface for connecting to and enabling manipulation by a robotic arm. The end effector also includes a probe guiding surface for deflecting and guiding a probe tip of a deflectable probe of the grapple fixture towards and through an opening in the probe guiding surface and into a grappling position as the end effector is moved towards the grapple fixture and the grapple fixture is within a capture envelope of the end effector. The end effector includes a probe sensing element for sensing when the probe tip is in the grappling position and triggering a capture mechanism upon sensing the probe tip in the grappling position; and the capture mechanism configured to grapple the probe tip when triggered by the probe sensing element. The end effector further includes an actuator configured to retract the capture mechanism along a capture axis when the probe tip is grappled to a first predetermined position at which a mating surface of a base of the grapple fixture is preloaded against the probe guiding surface to establish a load-bearing interface between the free flyer object and the end effector.

The probe guiding surface may be concave.

The end effector may further include a plurality of protrusions disposed on the probe guiding surface for mating with complementary recesses on the mating surface of the grapple fixture during capture to align the connection between the grapple fixture and the probe guiding surface of the end effector.

The probe guiding surface may include a raised annulus for mating to a complementary recessed annulus on the mating surface of the grapple fixture.

Each respective one of the plurality of protrusions may include a rounded surface to promote sliding of the fin along a side alignment surface of a respective one of the complementary recesses and onto a bottom surface of the respective complementary recess. In some embodiments, the protrusions may slide along the side alignment surfaces and not contact the bottom surface of the respective complementary recess. Rather an outer annulus surface of the end effector (the raised annulus) and an outer annulus surface of the grapple fixture (the recessed annulus) may come into contact and react loads at the interface (to spread the interface preload in a more beneficial manner). This may include leaving a slight clearance in the protrusions and recesses, within an acceptable alignment variance.

The capture mechanism may include a spring-based compliant member, and the actuator may be configured to further retract the capture mechanism to compress the compliant member to provide preload to the interface between the grapple fixture and the end effector. Use of such spring-based compliant member can provide preload to the interface that is less sensitive to manufacturing tolerances, promotes mechanism repeatability, and reduces thermal distortion due to differential coefficients of expansion. In other embodiments, the compliant member may be omitted and the capture mechanism can still generate a preload. Omission of the compliant member may, however, increase risk of losing preload or breakage of components if a more flexible element is not included in the preload path.

In an embodiment, the spring-based compliant member may be a Belleville spring stack.

The capture mechanism may include a pair of jaws connected to the probe sensing element and configured to move from an open position to a closed position to grapple the probe tip when the grapple probe tip triggers the capture mechanism to close. The capture mechanism may be configured to passively move to a closed state with a deflection of a trigger linkage. The probe sensing element may sense the triggered capture mechanism. For example, a limit switch may be used to sense that the capture mechanism has been triggered by presence of the probe tip.

The capture mechanism may include a concave insert component which forms part of the probe guiding surface including the opening when the capture mechanism is positioned fully forward along the capture axis and which is retracted with the capture mechanism during retraction.

A method of robotic capture of a free flyer object is also provided. The method includes moving an end effector via a robotic arm towards a grapple fixture on the free flyer object such that the grapple fixture is within a capture envelope of the end effector. The method further includes contacting a deflectable probe of the grapple fixture with a probe guiding surface of the end effector within the capture envelope, deflecting the deflectable probe towards an opening in the probe guiding surface with the probe guiding surface by continuing to move the end effector towards the free flyer object, and guiding the deflectable probe through the opening via the probe guiding surface and into a grappling position. The method further includes sensing the deflectable probe is in the grappling position and triggering a grappling mechanism and grappling the deflectable probe with the grappling mechanism to constrain linear motion of the free flyer object upon sensing the deflectable probe is in the grappling position. The method further includes retracting the grappled deflectable probe along a capture axis to a predetermined position to remove angular and lateral offsets of the free flyer object relative to the end effector and to bring a base of the grapple fixture into contact with the probe guiding surface and rigidizing the interface between the grapple fixture and the end effector by retracting the grappling mechanism to a point at which the grapple fixture is preloaded against alignment features on the probe guiding surface.

Moving the end effector via the robotic arm towards the grapple fixture further may include detecting a machine vision target on the free flyer object via a machine vision system and tracking the machine vision target with the machine vision system as the robotic arm moves the end effector towards the grapple fixture.

The method may include cushioning the initial contact between the deflectable probe and the probe guiding surface via a cushioning spring in the deflectable probe.

Moving the end effector via the robotic arm towards the grapple fixture on the free flyer object may include maintaining, via a robotic arm controller, a relative approach velocity/approach trajectory of the end effector and free flyer object within a predetermined velocity band known to promote successful soft capture of the grappled fixture.

A capture tool for performing robotic capture of a free flyer object having a grapple fixture mounted thereon is also provided. The capture tool includes a probe guiding surface, a grapple, and a hard capture mechanism. The probe guiding surface guides a probe of the grapple fixture into a soft capture position. The grapple grapples the probe of the grapple fixture when the probe is in the soft capture position to constrain linear motion of the probe tip. The hard capture mechanism constrains angular motion of the probe by retracting the grappled probe until the grapple fixture is preloaded against the probe guiding surface to establish a load-bearing interface between the free flyer object and the capture tool.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a flow chart of a method of robotic capture of an object, such as a free flyer object, according to an embodiment,

FIG. 2 is a block diagram of a system for robotic capture of an object, according to an embodiment;

FIG. 3A is a schematic diagram of a free-flyer capture system including a servicing satellite and a free flyer object, showing a robotic arm of the free-flyer capture system moving from a parked position to a ready for capture position and the free flyer object moving from a first position into a second position, according to an embodiment;

FIG. 3B is a schematic diagram of the free-flyer capture system of FIG. 3A showing capture of the free flyer object by the robotic arm of the servicing satellite through connection between an end effector and a grapple fixture on the free flyer object, according to an embodiment;

FIG. 3C is a schematic diagram of the free-flyer capture system of FIGS. 3A and 3B showing the robotic arm moving the captured free-flyer object from a pre-berth position to a berth position, according to an embodiment;

FIG. 4A is a schematic diagram of the free flyer capture system of FIGS. 3A-3C further performing transfer of an orbital replacement unit (ORU) from the free flyer object to the servicing satellite, including capture of the ORU with the end effector, according to an embodiment;

FIG. 4B is a schematic diagram of the free flyer capture system of FIG. 4A performing transfer of the captured ORU from the free flyer object to the servicing satellite and power transfer to the ORU by the servicing satellite, according to an embodiment;

FIG. 5A is a front perspective view of an end effector for capturing a free flyer object, according to an embodiment;

FIG. 5B is a front view of the end effector of FIG. 5A;

FIG. 5C is a side view of the end effector of FIG. 5A;

FIG. 6A is a front perspective view of a grapple fixture for mounting to a free flyer object and capture by the end effector of FIGS. 5A to 5C, according to an embodiment;

FIG. 6B is a front view of the grapple fixture of FIG. 6A;

FIG. 6C is a cross-sectional side view of the grapple fixture of FIG. 6A;

FIG. 7A is a cross-sectional side view of an end effector at a first stage of a capture sequence, according to an embodiment;

FIG. 7B is a cross-sectional side view of the end effector of FIG. 7A at a second stage of the capture sequence, according to an embodiment;

FIG. 7C is a cross-sectional side view of the end effector of FIG. 7A at a third stage of the capture sequence (soft capture achieved), according to an embodiment;

FIG. 7D is a cross-sectional side view of the end effector of FIG. 7A at a fourth stage of the capture sequence, according to an embodiment;

FIG. 7E is a cross-sectional side view of the end effector of FIG. 7A at fifth stage of the capture sequence (all misalignments removed and surfaces seated), according to an embodiment;

FIG. 7F is a cross-sectional side view of the end effector of FIG. 7A at a sixth stage of the capture sequence (rigidized), according to an embodiment;

FIG. 8A is a schematic cross-sectional side view of a capture sequence including the grapple fixture of FIGS. 6A to 6C and the end effector of FIGS. 7A to 7F showing the grapple fixture misaligned as it approaches a receiving end of the end effector, according to an embodiment;

FIG. 8B is a schematic cross-sectional side view of a capture sequence including the grapple fixture of FIGS. 6A to 6C and the end effector of FIGS. 7A to 7F, showing initial contact between a probe tip of a deflectable probe of the grapple fixture and a probe guiding surface of the end effector, according to an embodiment;

FIG. 8C is a schematic cross-sectional side view of a capture sequence including the grapple fixture of FIGS. 6A to 6C and the end effector of FIGS. 7A to 7F, showing deflection of the deflectable probe by the probe guiding surface towards an opening in the probe guiding surface, according to an embodiment;

FIG. 8D is a schematic cross-sectional side view of a capture sequence including the grapple fixture of FIGS. 6A to 6C and the end effector of FIGS. 7A to 7F, showing the probe tip of the deflectable probe having entered the interior compartment of the end effector through the opening and into a grapple position, according to an embodiment;

FIG. 8E is a schematic cross-sectional side view of a capture sequence including the grapple fixture of FIGS. 6A to 6C and the end effector of FIGS. 7A to 7F, showing the probe tip of the deflectable probe having triggered grappling of the probe tip by a capture mechanism of the end effector through contact with a probe sensing element, according to an embodiment;

FIG. 8F is a schematic cross-sectional side view of a capture sequence including the grapple fixture of FIGS. 6A to 6C and the end effector of FIGS. 7A to 7F, showing initial retraction of the capture mechanism and grappled deflectable probe along a capture axis towards a hard capture position, according to an embodiment;

FIG. 8G is a schematic cross-sectional side view of a capture sequence including the grapple fixture of FIGS. 6A to 6C and the end effector of FIGS. 7A to 7F, showing the capture mechanism having retracted to a hard capture position to rigidize the interface between the grapple fixture and the end effector, according to an embodiment; and

FIG. 8H is a schematic cross-sectional side view of a capture sequence including the grapple fixture of FIGS. 6A to 6C and the end effector of FIGS. 7A to 7F, showing the capture mechanism having been driven forward along the capture axis to disengage the probe tip to enable release of the grapple fixture, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to robotic systems and devices, and more particularly to a robotic device for capturing a free flying object.

The term “free flying object”, “free flyer object”, or “free flyer” as used herein refers to an object that is not fixed in an inertial frame. That is, the object is free to move or accelerate in a number of degrees of freedom. Forces resulting from contact with another object will therefore tend to accelerate the free flyer in the opposite direction. Strong initial contact forces during an attempted capture of the free flyer object will tend to “tip off” the object; this is why the robotic capture systems and devices of the present disclosure are configured to perform a “soft capture” (low forces applied at relatively high speed to prevent tip off) and a “hard capture” or “rigidization” (high forces at relatively low speed after tip off has already been prevented by soft capture). Generally, a free flyer object is not physically connected to the “capturing” body, which is the body to which the robotic capture device is connected. The “capturing” body has the ability to control itself in six degrees of freedom (DOF) but has no control of the relative 6-DOF between the capturing body and the free flyer. The free flyer in a relative sense, and “free flyer capture” is the act of gaining control of the relative 6 DOF motion between the capturing body and the free flyer. On Earth, two bodies that are not directly connected do often have an indirect connection through gravity and friction and the ground in between the objects and as such are not unconstrained free flyers. The systems and methods of the present disclosure can be used to facilitate capture in other environments where tip-off of the capture object may occur during a grapple attempt. Additional environments in which the systems and methods may find application include underwater/subsea environments or in space/in-flight, when the object is buoyant within the atmosphere or in free-fall. The systems and methods may be used in Earth-based environments, for example, where some if not all DOFs are uncontrolled. One such example is a load suspended from a crane that needs to be captured and controlled.

Generally, the present disclosure provides systems, methods, and devices for robotic capture of an object including capturing the object by grappling a grapple fixture attached to the object and rigidizing the interface between the end effector and the grapple fixture to establish a load-bearing interface such that the object can be manipulated by a robotic system. The manipulation may include, for example, moving the object from one location to another, or passing any one or more of power, data, or torque through the end effector to the object. The object, referred to herein as a “capture object”, may be an object that is not connected to whatever system the robotic arm used to manipulate the end effector is connected to, making alignment generally more challenging. For example, the object may be a free floating underwater object or a free flying object (free flyer object, such as an active, functioning satellite, a decommissioned or failed satellite, a spent upper stage of a launch vehicle, or an orbital debris object). Accordingly, the end effector of the present disclosure may be configured to have a relatively large capture envelope to address potential for misalignment during approach and capture.

The robotic capture systems and devices of the present disclosure may also be used to perform “pick and place” manipulation of objects, grasping an object and enabling moving the object to another location at the end of a robotic manipulator system. The robotic capture systems and devices of the present disclosure may also be used to perform docking of a free-flyer object in which the free-flyer includes an end effector and a larger ‘more stationary’ object includes the grapple fixture. In such a case, a servicer spacecraft may do all the maneuvering without a robotic arm. As such, the free-flyer capture mechanism may reside on either the servicer or the client.

The robotic capture systems, methods, and devices of the present disclosure advantageously provide a less expensive method for free flyer capture than existing methods, such as the “snare-cable”-based method used on shuttle and station arms. The systems, methods, and devices may be used for smaller, lighter free flyers than existing snare-cable methods, while also being scalable for use with larger, heavier free flyer objects. For example, embodiments described herein including a compliant probe, mousetrap capture mechanism, and rigidize motor provide a particularly simple implementation capable of capturing free flyer objects.

In an embodiment, the end effector is directed by a robotic arm to approach the grapple fixture. The grapple fixture includes a probe having a tip that contacts a probe guiding surface of a receiving end of the end effector. The tip is guided by the probe guiding surface through an opening in the probe guiding surface and into a grappling position. The presence of the probe in the grappling position is sensed by the end effector and a capture mechanism is engaged to grapple the tip of the probe of the grapple fixture. The capture mechanism is retracted, drawing the probe further into the end effector and bringing a base of the grapple fixture into mating contact with the probe guiding surface. The capture mechanism is retracted to a position at which the interface between the grapple fixture and the end effector is rigidized and a desired preload is generated. The captured and rigidized object can then be manipulated by a robotic system, such as by maneuvering the object via the robotic arm.

The foregoing multi-stage capture and rigidization may advantageously allow for an easier and more successful initial capture of the object. The multi-stage approach advantageously allows for rotation of the object in order to effect a proper alignment for more fulsome capture.

As used herein, the term “end effector” refers generally to a robotic device or element at the end of a robotic arm that performs a function. In the present disclosure, that function includes capturing a free flying asset. The term “end effector” as used herein includes devices that are permanently or non-separably mounted to the end of the robotic arm and devices having a separable interface with the end of the robotic arm. A separable interface may allow the end effector to be picked up, used, and put down (i.e., separated from the robotic arm). Instances of the end effector having a separable interface may also be referred to as a “tool” or “end of arm tool”. In such an instance, the robotic arm may have a first end effector mounted to its end which has the function of a tool-changer that allows the robotic arm to use multiple different tools, and a second end effector having the separable interface and which can be engaged by the first end effector and function as a tool. In such a case, the first “tool-changer” end effector and the second “tool” end effector are each considered an end effector. Accordingly, any references to “end effector” herein are intended to include all devices as described in the foregoing unless otherwise noted.

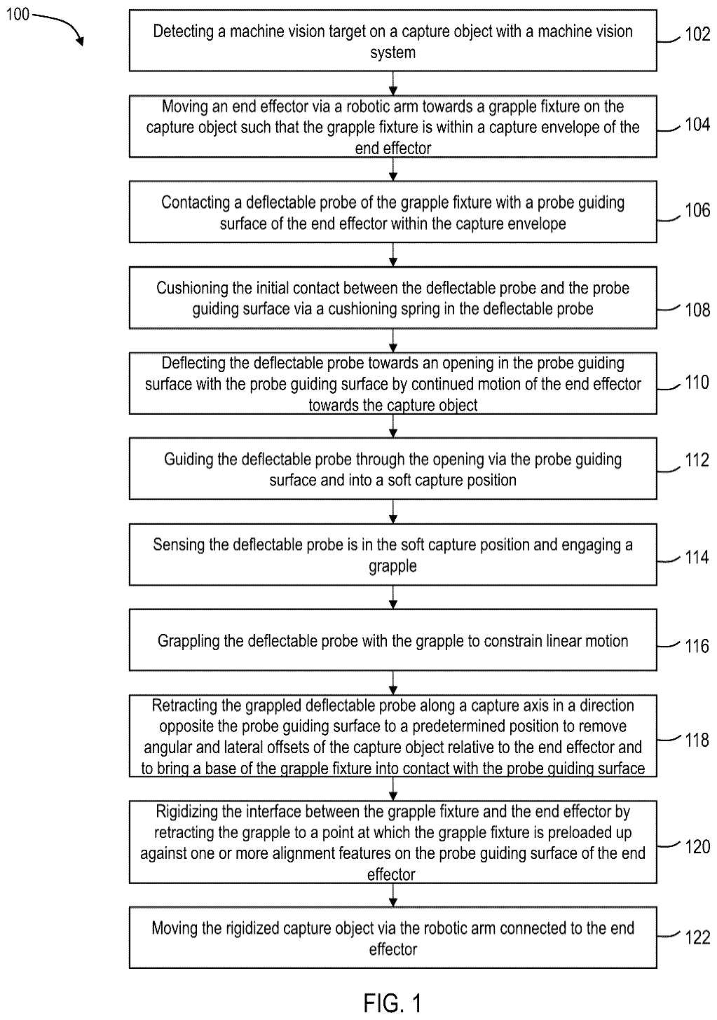

Referring now to FIG. 1, shown therein is a method 100 of robotics-based object capture, according to an embodiment. The method 100 may be performed using a robotics system including a machine vision system, a robotic arm controller, a robotic arm, and an end effector. In an embodiment, the method 100 may be used to capture a free flyer object in a space-based application, such as a satellite or the like.

At 102, a machine vision target mounted on an object to be captured (“capture object”) is detected by the machine vision system. The capture object may be a free flyer object. The machine vision system may then generate a signal that the capture object has been detected and communicate the signal to the robotic arm controller.

In some cases, the capture object may also be referred to as a “target object”. The object or vehicle performing the capture via the end effector, and to which the end effector is connected, may be referred to as a “chaser”. For example, in a space-based application, the chaser may be a spacecraft.

In variations where the capture object is a free flyer object, the free flyer object may be, for example, a free flyer object that is only doing attitude control, a free flyer object that has thrusters that can be used for propulsion to control its orbit also, or a free flyer object that no longer has either attitude or reaction control.

Generally, “capture” refers to the process of an end effector or capture tool and grapple fixture (on the capture object) as described herein transitioning from an ungrappled state to a grappled and rigidized state. This process may typically be used to achieve bringing the capture object, such as a free flyer, to the same velocity as the capturing object on which the end effector is disposed.

As described herein, the capture process includes both “soft capture” and “hard capture” processes. Hard capture may also be referred to as rigidization. Soft capture may be considered the process by which an inseparable connection is established between the grapple fixture on the capture object and the end effector that constrains some but not all degrees of freedom. Generally, this includes constraining linear motion of a tip of the grapple probe of the grapple fixture. For example, the center of the probe tip may be constrained in x/y/z, while grapple fixture (and capture object) motion relative to that constrain point is allowed. In hard capture, all degrees of freedom are constrained. This may include constraining angular motion, such as by removing angular and lateral offsets. Hard capture may be achieved by retracting the grapple probe to a predetermined position at which the grapple fixture is preloaded against the end effector to establish a load-bearing interface between the capture object and the end effector.

At 104, the robotic arm moves the end effector towards a grapple fixture on the capture object. The grapple fixture is used to enable grappling and capture of the capture object and may be a standardized interface. The robotic arm controller is configured to control the movement of the robotic arm at 104 such that the grapple fixture is within a capture envelope of the end effector as the end effector approaches the grapple fixture.

The term “capture envelope” as used in the present disclosure will now be described. When a capture or docking device is being positioned for use, the device needs to be placed in a certain relative position with respect to the grapple element or fixture of the capture object in order to ensure that, when the soft capture operation is executed, the mechanism will successfully close around the grapple fixture. While the capture operation is occurring, there are a number of effects that work against successful capture, including that the mechanism itself has certain geometric and dynamic positioning requirements, the vision system has a certain amount of measurement uncertainty, and the capture object is still potentially drifting with respect to the capture system's platform. Adding up all these effects (potential errors) yields a positioning requirement in x, y, z, yaw, pitch, roll that the capture mechanism must be inside to guarantee capture. This is referred to as the “capture envelope”. The larger the capture envelope, the more objects can be captured for a given set of these effects (drift rates, targeting and positioning accuracy, system speed to keep up with a ‘tumbling’ or ‘drifting’ FF). Also there can be a minimum “capture envelope” required based on the effects in the system that work against capture. A larger envelope gives margin on the ability to capture making the free flyer capture sequence more reliable.

The machine vision system may continue to track the capture object via the machine vision target and communicate with the robotic arm controller to keep pace with the capture object and perform a final inward (towards the capture object) motion guided by the target to get the grapple fixture (e.g., a probe tip of the grapple fixture) within the capture envelope. For example, the robotic arm controller may control the robotic arm to close in on the capture object at a prescribed rate. This may include tracking the capture object and, as the capture object is drifting, the robotic arm controller controls the arm to keep pace such that there is a constant vector between the end effector and the capture object. At an appropriate point, the robotic arm controller may then add a delta command. The delta command represents the closing velocity to bring the receiving end of the end effector towards the grapple fixture of the capture object. The delta command may include closing in within a particular velocity range (e.g., predetermined band, as described below).

The robotic arm controller may be configured to move the robotic arm and end effector towards the capture object at a prescribed rate such that the relative velocity of the end effector and the capture object are maintained within a predetermined band. The predetermined band represents a range of relative velocities which are known to promote or result in successful soft capture of the grapple fixture (e.g., through sliding along the probe guiding surface and through the opening into the interior compartment, as described below). The predetermined relative velocity band may be determined based on a variety of system characteristics (including characteristics of the robotic system and the capture object). Such system characteristics may include, for example, characteristics of a deflectable probe of the grapple fixture such as spring stiffness or frictional characteristics of the probe and the probe guiding surface. Maintaining the relative velocity of the capture object and the end effector on approach can be particularly important in free flyer capture applications as having such relative velocity be too fast or too slow can cause failure to have the probe of the grapple fixture contact the probe guiding surface, deflect, and slide on the probe guiding surface through the opening into the interior compartment for grappling.

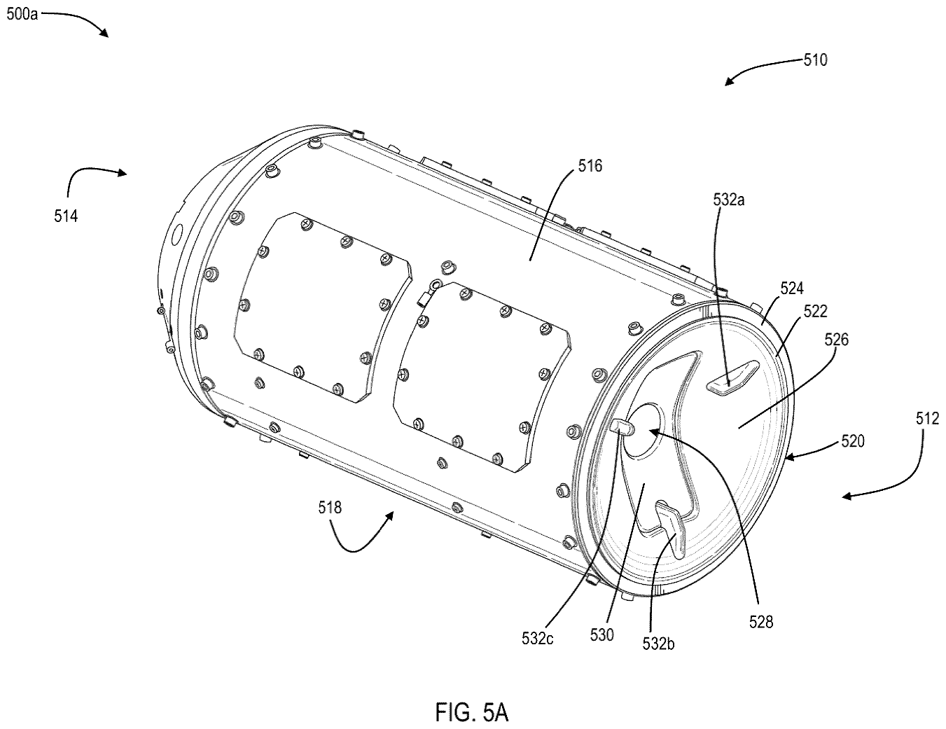

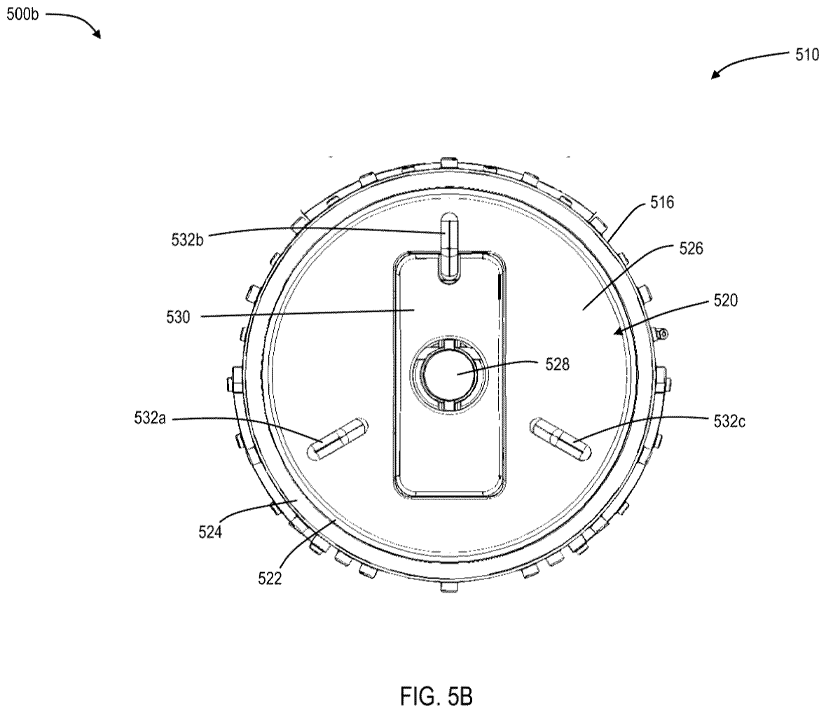

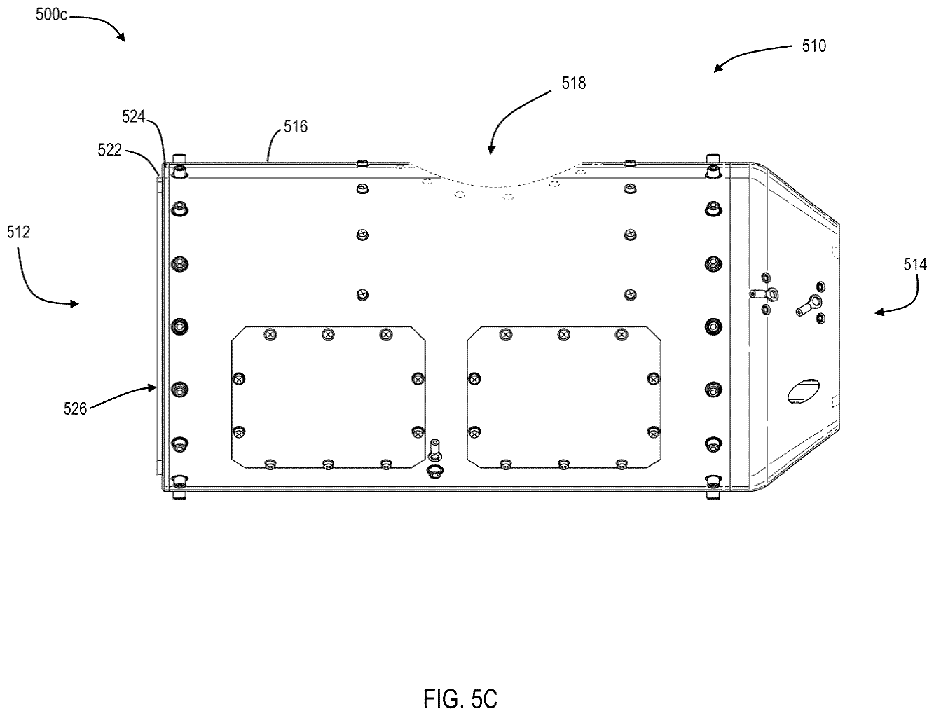

It is important that a useful capture device be forgiving with respect to the relative velocity between the capture system and the capture object. Much of the robotic capture system design is driven by factors or principles such as reducing friction, minimizing spring stiffness, reducing tip off forces, and increasing the speed of action of the soft capture. The need to achieve rigidization sometimes infringes on these driving principles. For example, fins on the capture device that ensure good constraints on roll after capture (e.g., fins 532 of FIG. 5A, 5B) can create an impediment to soft capture which has been mitigated to an extent by the design to keep the capture envelope as large as possible and reduce the relative rate requirement on the capture system. The means of achieving roll constraint in the rigidized state necessarily will compromise the largest possible capture envelope of the design and getting that envelope as large as possible adds margin to successful soft capture capacity. The device of the present disclosure accommodates misalignment through a flexible member within the capture system. The deflection of the flexible member (probe) to correct the misalignment occurs on contact with the free flyer. It takes a small amount of energy (in the form of force-times-displacement) to deflect the flexible member into alignment. If the approach is too slow, the free flyer object will be pushed away from the end effector capture device before “soft-capture” can be achieved. The minimum rate at which capture can still be achieved is based on the inertia of the free flyer (mass and rotational mass-inertia, trigger force) and the trigger force of the soft capture mechanism itself. Thus, the capture system is configured to achieve a minimum relative rate between the capture tool (chaser side) and the grapple fixture (free flyer side) for effective capture.

At 106, a deflectable probe of the grapple fixture contacts a probe guiding surface on a receiving end of the end effector within the capture envelope.

At 108, the initial contact between the deflectable probe and the probe guiding surface at 106 is cushioned by a cushioning spring in the deflectable probe. Such cushioning of the initial impact may prevent the probe from bouncing off of the receiving end of the end effector. This may be particularly advantageous in applications where the capture object is a free flyer object.

At 110, the deflectable probe is deflected by the probe guiding surface from a resting position (e.g., probe perpendicular to the surface of the capture object on which the grapple fixture is mounted) towards an opening in the probe guiding surface located at or near the center of the probe guiding surface by the continued motion of the end effector towards the capture object. The probe guiding surface may be concave to promote deflection of the deflectable probe in the direction of the opening. The opening provides entry by the deflectable probe to an interior compartment of the end effector in which a capture mechanism is disposed.

The deflectable probe includes a deflection element for enabling the probe to deflect from a resting position in the direction of an applied force and to return to the resting position upon removal of the applied force. In the case of 110, the shape of the probe guiding surface and the motion of the end effector towards the capture object applies a force to the deflectable probe which deflects the probe in the direction of the opening in the probe guiding surface. The deflectable element may include one or more spring components to facilitate deflection.

At 112, the probe guiding surface guides the deflected probe through the opening and into a soft capture position (or grapple position) in the interior compartment. The continued motion of the end effector towards the capture object and the profile of the probe guiding surface causes the continued deflection of the deflectable probe and sliding of the end of the deflectable probe across the probe guiding surface towards and through the opening.

At 114, the presence of the deflectable probe in the soft capture position is sensed by the end effector, triggering a grapple mechanism (“grapple”) of the end effector.

In an embodiment, the sensing of the deflectable probe may be performed by positioning a sensing element or trigger in line with the capture axis (the axis on which the deflectable probe is oriented in the interior compartment of the end effector) which is contacted by the end of the deflectable probe as the deflectable probe enters the opening and into the interior compartment of the end effector. The force applied to the sensing element by the contact of the deflectable probe may then cause the sensing element to engage the grapple.

Any suitable method for sensing the presence of the probe may be used and the type of sensing is not particularly limited. For example, in variations, sensing the presence of the probe may be achieved via any one or more of force tripping a microswitch, force as measured by an appropriately placed load cell/strain gauge, optical methods, capacitive methods, inductive methods, and electrical resistive methods. Force tripping of a microswitch may advantageously provide a simple and effective way of measuring state change. Other sensing methods can in general be used if such methods make sense for a certain embodiment.

At 116, the deflectable probe is grappled by the grapple. Grappling of the deflectable probe constrains linear motion of the capture object relative to the end effector. In an embodiment, the grapple may include a pair of jaws configured to move from an open position to a closed position when triggered, thereby grabbing the probe. In an embodiment, the end of the probe is spherical to enable grappling of the probe (and also to promote sliding of the probe along the probe guiding surface).

At 118, the grappled deflectable probe is retracted in the interior compartment of the end effector along a capture axis in a direction opposite the receiving end of the end effector to remove angular and lateral offsets of the capture object relative to the end effector. Generally, in some embodiments, roll misalignment must be maintained within a specified maximum value between soft capture and rigidize. It is possible that after soft capture, if the roll misalignment continues to grow beyond the maximum allowable misalignment, rigidize may not occur. The grappled probe may be retracted to a predetermined position. The predetermined position may be detected by a potentiometer or the like. Retraction of the grappled probe brings a base of the grapple fixture, which is connected to the deflectable probe, further towards and into contact with the probe guiding surface. The base of the grapple fixture and the probe guiding surface may be complementarily shaped to promote sliding of the base along the probe guiding surface and/or mating of the base to the probe guiding surface. The grapple fixture base and the probe guiding surface may each include alignment features configured to interface with one another and promote alignment between the grapple fixture base and the probe guiding surface as the probe is retracted and the end effector and capture object are moved closer together.

At 120, the interface between the grapple fixture and the end effector is rigidized. Rigidization is achieved by retracting the grapple to a point at which the grapple fixture is preloaded up against one or more alignment features on the probe guiding surface of the end effector. For example, in some embodiments, preload may be on a contacting annulus, as described herein. In other embodiments, preload may be on a plurality of protrusions (or ‘fins’). In a particular embodiment, alignment features include a raised contacting annulus and a plurality of fins, and the grapple fixture is preloaded against the raised contacting annulus and not the alignment fins.

Rigidization of the interface allows for complete authority by the capturing system to define the relative position and orientation of the capture object. This allows for low uncertainty of, and control of, the relative position and rates between the two objects. This state is typically preferred for situations where the robotic servicer is then going to apply loads while it fixes, adjusts, or refuels the captured object or the robotic servicer is propelling the capture object into a new orbit or into a new attitude. In the soft capture state, the capture system has some authority over the capture object in certain DOF but not others (so it does not have an ability to generate a force or moment against the free flyer object in order to maneuver it into any position and orientation). Once achieved, the hard capture or rigidized state provides the ability to generate forces and moments in all directions against the capture object (e.g., like holding a handle mounted to the object). Having 6-DOF and being determinant in where the free flyer is being held allows handling of the object and alignment of the object with other connecting features or other servicing features such as robotic servicing systems, refueling systems, or the like.

At 122, the rigidized capture object is manipulated (e.g., moved) by the robotic arm connected to the end effector. In an example, the capture object may be moved to a berthing position.

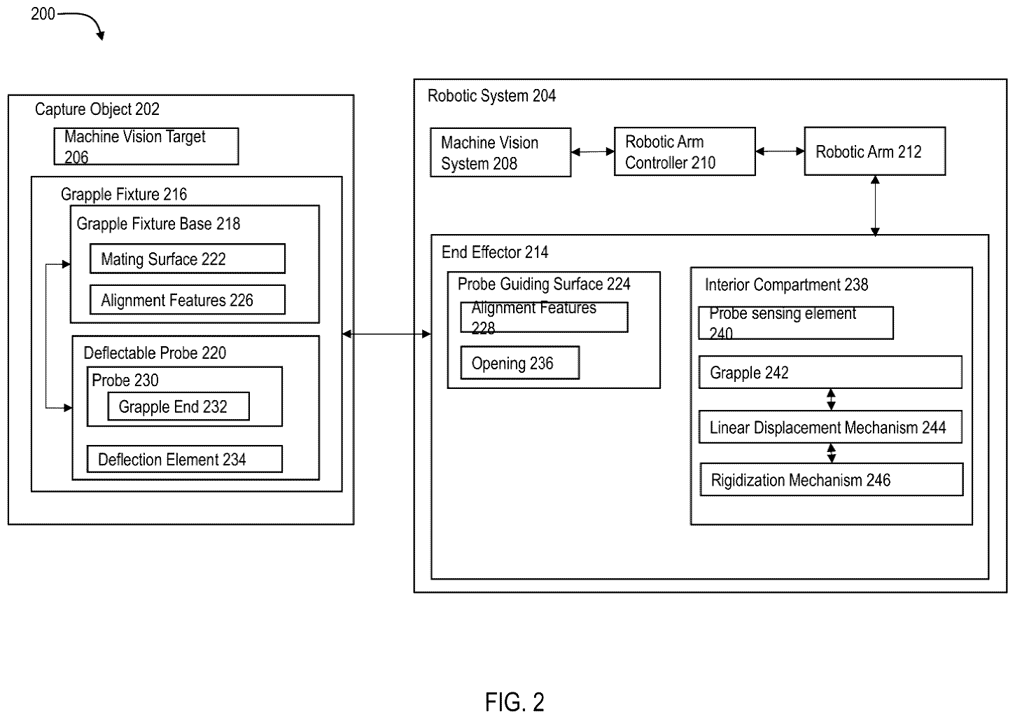

Referring now to FIG. 2, shown therein is a system 200 for robotic capture of an object, according to an embodiment. The system 200 may be used to capture a free flying object, such as a satellite. The system 200 may be used to implement the method 100 of FIG. 1.

The system 200 includes a capture object 202 and a robotic system 204 for capturing the capture object 202 and manipulating the capture object 202 once captured.

The capture object 202 includes a machine vision target 206 on the capture object 202. The machine vision target 206 is positioned on the capture object 202 such that a machine vision system 208 of the robotic system 204 can detect and track the machine vision target 206.

The machine vision system 208 may include a camera for visualizing the machine vision target 206, a processor for generating and processing image data collected by the camera, a memory for storing the image data, and a communication interface for communicating with other components of the robotic system 204 (e.g., communicating information about detection and tracking of the machine vision target 206).

The robotic system 204 also includes a robotic arm controller 210 for controlling movement of a robotic arm 212. The robotic arm controller 210 includes a processor for processing data, a memory for storing data, and a communication interface for communicating with the machine vision system 208 and the robotic arm 212. For example, the robotic arm controller 210 may receive data from the machine vision system 208 regarding the detection and tracking of the machine vision target 206 (and thus, the capture object 202) and generate arm movement commands based on the received machine vision data. The robotic arm controller 210 may then send the arm movement commands to the robotic arm 212 to control movement of the robotic arm 212.

In some cases, the robotic arm controller 210 may be configured to determine a relative approach velocity and maintain the relative approach velocity within a predetermined range for promoting soft capture of the capture object 202.

The robotic system 200 also includes an end effector 214 connected to the robotic arm 212. The end effector 214 is configured to capture (grapple and rigidize) the capture object 202 via a grapple fixture 216 on the capture object 202. The end effector 214 may also be configured to pass any one or more of power, data, and torque to the capture object 202 through interfaces present on the capture object 202 once captured.

The grapple fixture 216 may be mounted to the capture object 202 at a location near the machine vision target 206 such that the machine vision target 206 can be used to direct the end effector 214 towards the grapple fixture 216 for capture.

The grapple fixture 216 includes a base 218 and a deflectable probe 220 connected to the base 218.

The base 218 is mounted to an external surface of the capture object 202. The deflectable probe 220 is connected to the base 218 such that the deflectable probe, when at rest (i.e., not deflected), is generally perpendicular to the base 218.

The base 218 includes a mating surface 222 configured to interface and mate with a probe guiding surface 224 of the end effector 214 during capture.

The mating surface 222 includes one or more alignment features 226. The alignment features 226 are configured to interface with complementary alignment features 228 on the probe guiding surface 224. The alignment features 226 are configured to promote alignment of the grapple fixture 216 and the probe guiding surface 224 through contact with the alignment features 228. The alignment features 226, 228 may be used to generate required preload of the end effector-grapple fixture interface.

In some embodiments, preload may only be on a subset of the alignment features 226, 228 (or only a subset of alignment features may be used to react loads at the interface). For example, in a particular embodiment, the alignment features 228 may include a raised contacting annulus and a plurality of alignment fins with complementary alignment features 226 on the grapple fixture, and only the annulus is used to react loads at the interface (preload only at contact annulus, not fins; ‘annulus reaction’). In embodiments in which the alignment features comprise a contacting annulus, an outer annulus surface of the end effector (the raised annulus) and an outer annulus surface of the grapple fixture (the recessed annulus) may come into contact and react loads at the interface, which may advantageously spread the interface preload in a more beneficial manner.

In another embodiment, the annulus may be absent, and the alignment fins may be used to react loads at the interface (‘fin reaction’).

The alignment features 226, 228 may be used to provide rotational and shear alignment of the grapple fixture 216 and end effector 214 when bringing the two together.

The alignment features 226, 228 may also be configured to allow for some level of offset (e.g., lateral, rotational) between the grapple fixture 216 and the end effector 214 during capture. This may be particularly advantageous in applications where the capture object 202 has a tumble rate, such as in the case of a free flyer object.

The alignment features 226, 228 may be configured to cause self-alignment of the interface as a result of rotational misalignment (e.g., 5 degrees offset).

The deflectable probe 220 of the grapple fixture 216 includes a probe 230 including a shaft that terminates at a grapple end 232. The grapple end 232 may have a diameter greater than a diameter of the shaft. The grapple end 232 may comprise a spherical tip. In cases where the grapple end is rounded or spherical, the grapple end 232 may be referred to as a “grapple ball”.

The deflectable probe 220 also includes a deflection element 234 for enabling deflection of the probe 230 in the direction of an applied force. The deflection element 234 is also configured to return the probe 230 to a resting state (not deflected, no applied force) when the applied force is removed. The amount of applied force required to deflect the deflection element 234 may vary depending on the material used. In an embodiment, the deflection element comprises one or more springs. In an embodiment, the deflection element 234 comprises a spring-centered spherical joint.

In an embodiment, the probe 220 is configured to allow 3DOF rotation and lateral/off-axial deflection.

The deflection element 234 is connected to the probe 230 and the base 218 to facilitate deflection relative to the base 218. In some cases, the probe 230 may also be directly attached or mounted to the base 218.

Generally, as the robotic arm 212 moves the end effector 214 towards the grapple fixture 216 of the capture object 202, the grapple end 232 of the deflectable probe 220 contacts the probe guiding surface 224 of the end effector 214.

The probe guiding surface 224 is curved to promote deflection of the deflectable probe 220 towards an opening 236 upon contact with the grapple end 232. The opening 236 may be located at or near the center of the probe guiding surface 224. In cases where the probe guiding surface 224 is concave, the opening 236 may be located at a vertex of the concave probe guiding surface 224.

The probe guiding surface 224 is composed of a material suitable to enable the grapple end 232 of the deflectable probe 220 to slide along the probe guiding surface 224. For example, the material may be selected to have suitable frictional force interaction between the probe guiding surface 224 and the grapple end 232. Similarly, the grapple end 232 is composed of a material suitable to enable the grapple end 232 to slide along the probe guiding surface 224 at a desired or acceptable level of friction.

Generally, the movement of the end effector 214 towards the grapple fixture 216, the deflection of the deflectable probe 220, and the shape and surface composition of the probe guiding surface 224 and grapple end 232 act together to guide the grapple end 232 through the opening 236 and into an interior compartment 238 of the end effector 214 for grappling.

The interior compartment 238 houses a probe sensing element 240, a grapple 242, a linear displacement mechanism 244, and a rigidization mechanism 246.

The probe sensing element 240 is configured to sense the presence of the grapple end 232 of the probe 230 and trigger the grapple 242 to grab the grapple end 232. The grapple 242 may also be referred to as a capture mechanism or soft capture mechanism.

The probe sensing element 240 is positioned near the opening 236 such that, when triggered by the grapple end 232 (such as by, for example, being depressed by or otherwise contacted by the grapple end 232), the grapple 242 can grab the grapple end 232. For example, in an embodiment, the grapple 232 may include a pair of jaws which are in an open state until triggered to close by the probe sensing element 240. The probe sensing element 240 is positioned such that, in order for the grapple end 232 to trigger the probe sensing element 240 (e.g., by physical contact therewith), the grapple end 232 enters and occupies a space between the open jaws (“grapple position” or “soft capture position”). The jaws can then be closed to grapple the grapple end 232.

The grapple 242 may be configured to constrain three degrees of freedom (linear motion) of the grapple fixture 216 upon grappling the grapple end 232 of the probe 230.

Generally, the grapple 242 is configured to achieve soft capture of the grapple probe 230. In some embodiments, the grapple 242 is configured to passively move to a closed state with a deflection of a trigger linkage. The deflection may be achieved via physical contact with the probe tip 232. A sensor may be used to sense that the grapple 242 has been triggered. In an embodiment, the sensor is a limit switch.

The linear displacement mechanism 244 is configured to translate the grapple 242 along a capture axis of the end effector 214. Once the grapple 242 has grabbed the grapple end 232 of the deflectable probe 220, the linear displacement mechanism 244 retracts the grapple 242 (and the grappled probe 230) in a direction opposite the receiving end of the end effector 214. The retraction of the grapple 242 draws the deflectable probe 220 further into the interior compartment 238, which brings the mating surface 222 and alignment features 226 of the grapple fixture base 218 closer to and into contact with the probe guiding surface 224. As previously noted, in some embodiments, only a subset of alignment features 226 may contact.

In an embodiment, the linear displacement mechanism 244 includes two ball screws, a ball nut attached to each ball screw, and a motor for driving rotation of the ball screws. The ball nuts are attached to the grapple 242, and as the ball screw rotates the grapple 242 is translated via the ball nuts. By using two ball screws, the ball screws can be placed beside the rest of the mechanism, on each side, with balanced loads making the tool shorter. This design can be particularly advantageous in robotic arm operations where a longer package (e.g., using a single ball screw instead of the two ball screws) is not preferred. Nevertheless, in other embodiments, a single ball screw may be used.

The linear displacement mechanism 244 is configured to retract the grapple 242 to a hard capture position. As the grappled deflectable probe 220 is retracted, the angular and lateral offsets of the capture object 202 are removed.

Hard capture (rigidization) of the grapple fixture 216 is achieved when the probe 220 is retracted to a point at which the grapple fixture 216 is preloaded against the probe guiding surface 224. This may include contact and mating of the alignment features 226, 228.

In particular, the interior compartment 238 includes a rigidization mechanism 246 for rigidizing the interface between the grapple fixture 216 and the end effector 214. In an embodiment, the rigidization mechanism 246 includes a compressible element (e.g., Belleville spring stack) which is compressed via retraction of the probe 220 by the linear displacement mechanism 244 to a preload position (corresponding to a compression of the compressible element).

In an embodiment, the compressible element may be a spring-based compliant member. Use of such spring-based compliant member can provide preload to the interface that is less sensitive to manufacturing tolerances, promotes mechanism repeatability, and reduces thermal distortion due to differential coefficients of expansion. In other embodiments, the compressible or compliant member may be omitted and the capture mechanism can still generate a preload. Omission of the compliant member may, however, increase risk of losing preload or breakage of components if a more flexible element is not included in the preload path.

The compressible element provides a known stiffness deflection relationship. The use of the compressible element (e.g., Belleville stack) allows for keeping the load variation controlled. There are several effects that can cause loads to change once in the hard-capture or rigidized position. These effects include temperature, where the coefficient of thermal expansion (CTE) of the structure is different from the mechanism so a change in temperature causes a change in the position of the mechanism relative to the structure. This is particularly relevant when used in environments, such as space, where temperature can change drastically (e.g., −40 to +100° C.). The effects causing loads to change once hard-captured also include, for example, variation in length of the grapple probe from fixture to fixture and position variation/accuracy within the capture tool. The compressible element is a lower stiffness compliance that allows the hard capture load to be controlled passively without constant monitoring.

The capture mechanism may include a state change detection element for detecting when soft capture and retraction of the grapple fixture has been achieved and rigidization should be initiated using the preload generator component. In an embodiment, the state change detection element includes a potentiometer configured to detect when the grapple end 232 has reached a “seated” position. The state change detection element is connected to and triggers the preload generator element. In an embodiment, when the soft capture indicator is tripped is the state change detection element different from the soft capture indicator, the mechanism moves immediately to rigidize (hard capture) so that the interface cannot drift out of alignment before it comes together. The preload generator element may then be compressed until a desired (predetermined) preload is achieved. A power off brake may be used to avoid continuously losing power while holding onto the free flyer object (payload) when power is cut to the drive motor. Generally, the system is calibrated (e.g., on ground in a space application) to go to a specific position as the “hard-capture position”, which is a position that can only be attained (while holding a grapple fixture) by compressing the preload generator element (e.g., spring stack). In an embodiment using a spring stack, a middle point (or an approximate middle point) in the stroke of the stack may be used so that the varying effects (such as described above) do not move the rigidization load outside of a range. That range is based on the external loads that are to be reacted once rigidized (i.e., no separation of the interface) and the strength of the components in the system.

Once rigidized, the end effector 214 may send a signal to the robotic arm controller 210 that the capture object 202 is rigidized. The robotic arm controller 210 may then manipulate the robotic arm 212 by generating and sending arm movement commands to move the rigidized capture object 202 to a desired location.

The linear displacement mechanism 244 may also be used to release the grapple fixture 216 by driving the grapple 242 (or components thereof) forward along the capture axis to drive the grapple 242 into the open position, enabling release of the grapple end 232 and thus the grapple fixture 216.

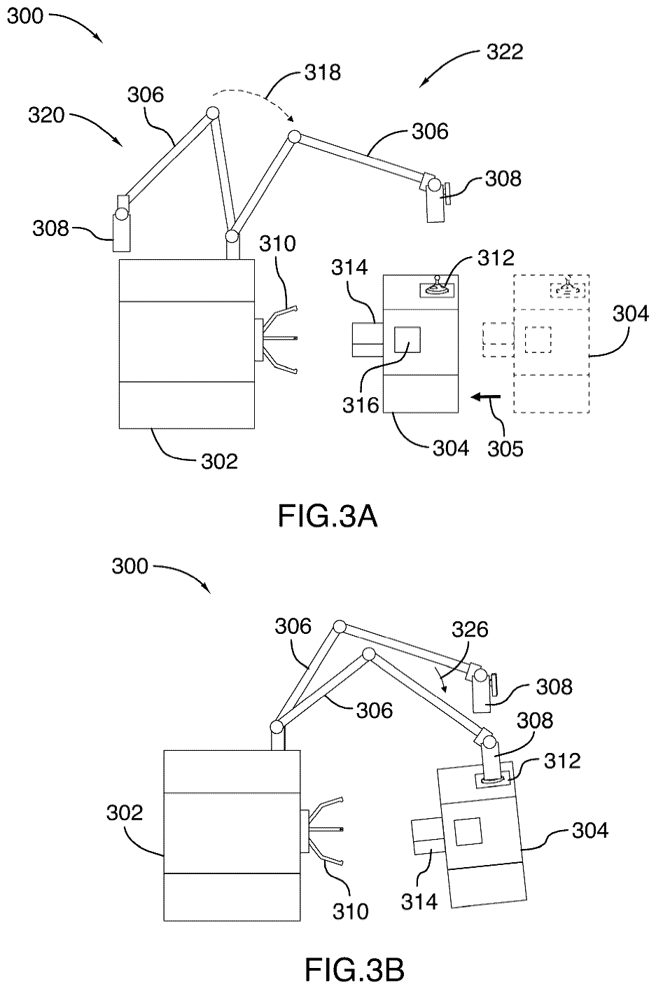

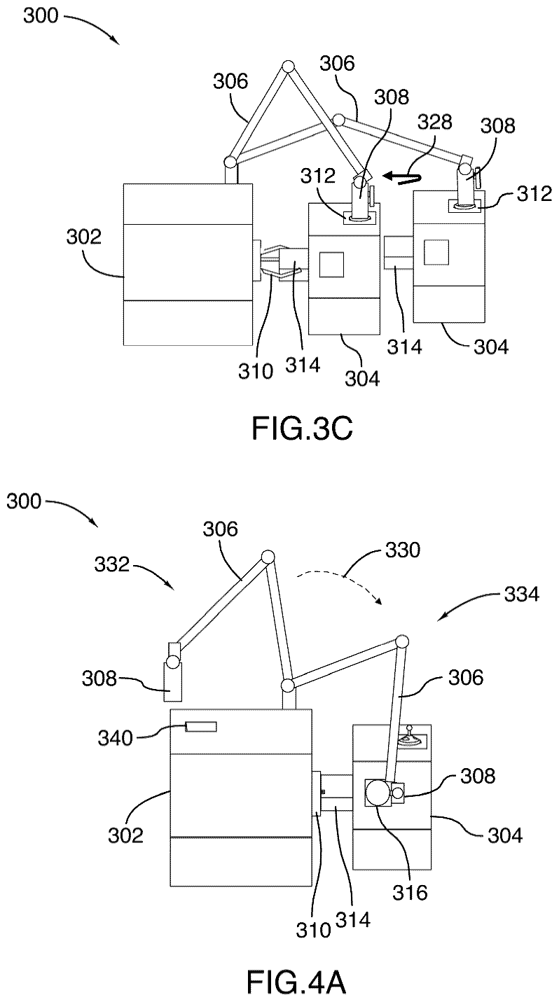

Referring now to FIGS. 3A-3C, shown therein is a free flyer capture system 300 including a servicing satellite 302 and a free flyer object 304, such as a satellite, performing a capture sequence, according to an embodiment. The system 300 is an example application of the system 200 of FIG. 2 and the method 100 of FIG. 1.

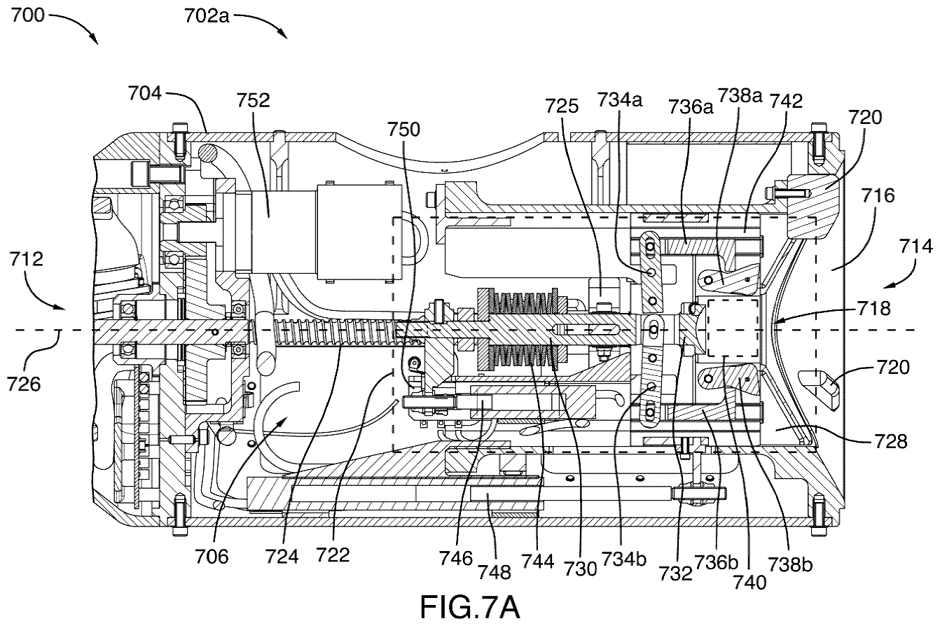

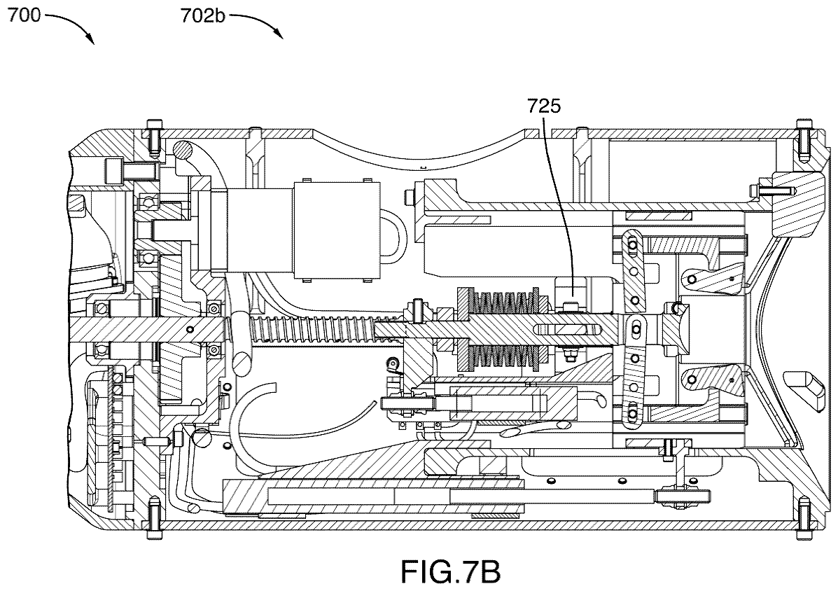

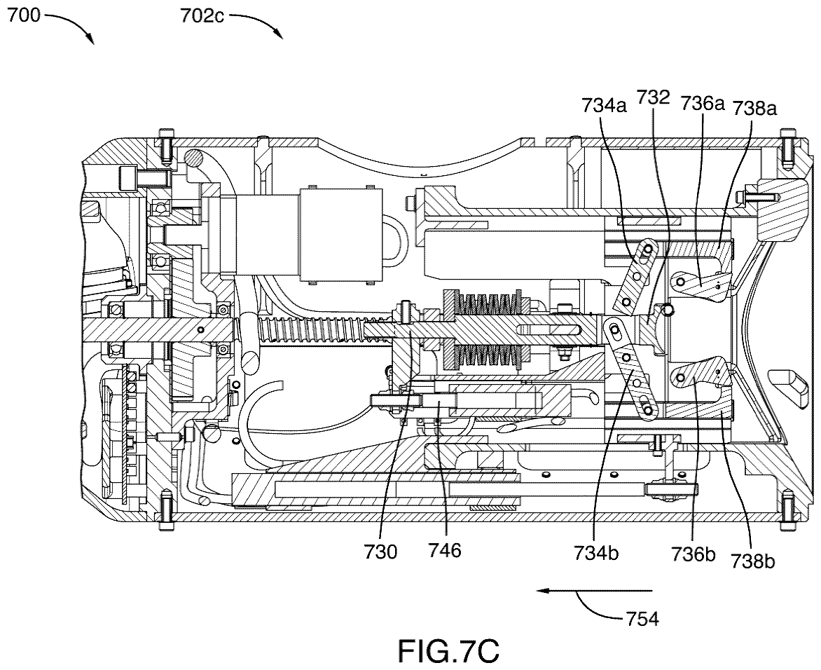

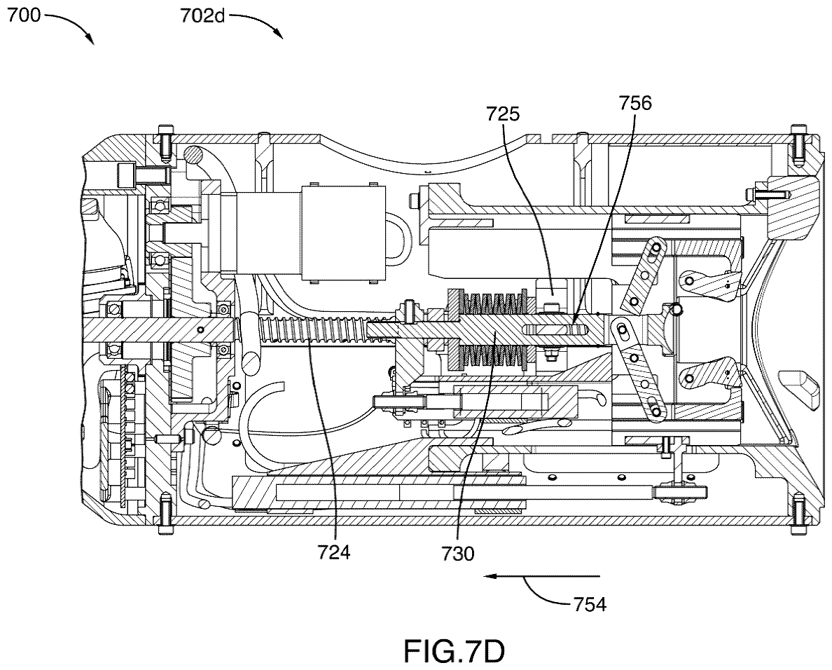

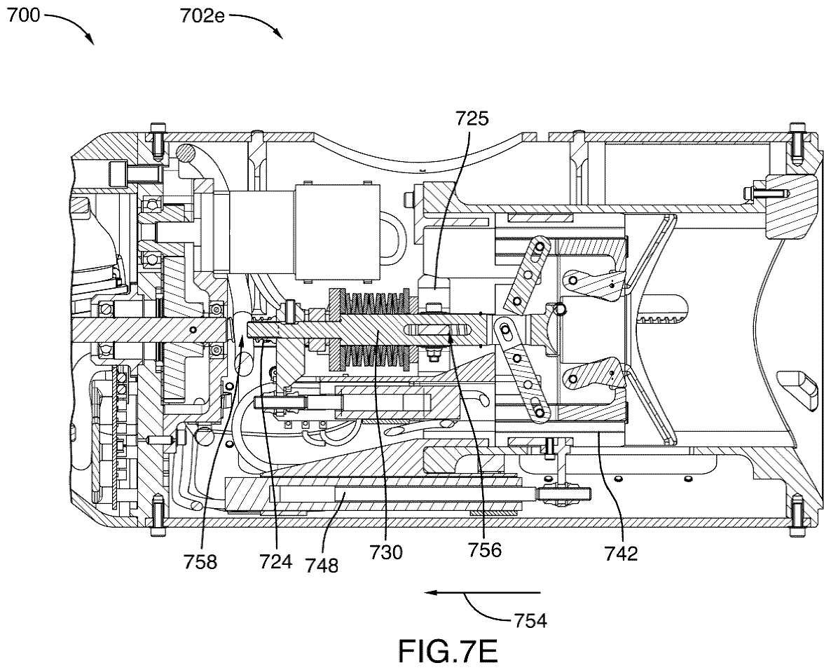

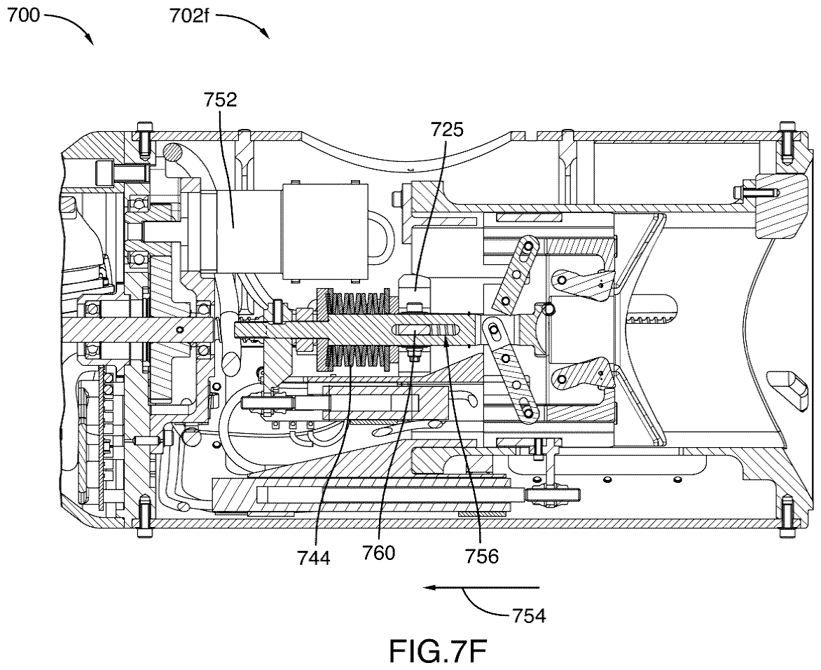

The servicing satellite 302 includes a robotic arm 306 attached to the servicing satellite 302 and an end effector 308 connected to the robotic arm 306 for performing capture of the free flyer object 304. The end effector 308 may be, for example, the end effector of FIG. 2, the end effector of FIGS. 5A-5C, or the end effector of FIGS. 7A-7F. The servicing satellite 302 also includes a servicing mechanism 310 for berthing and servicing the free flyer object 304.

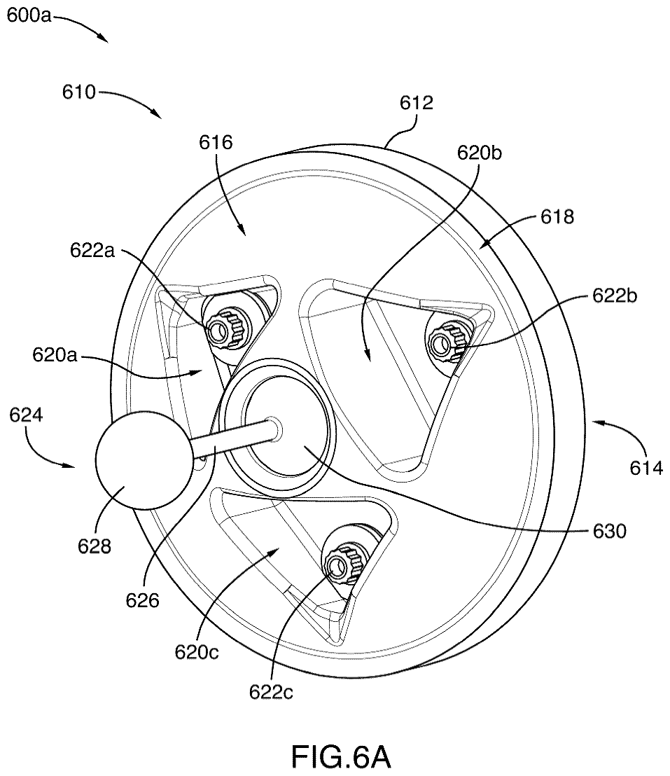

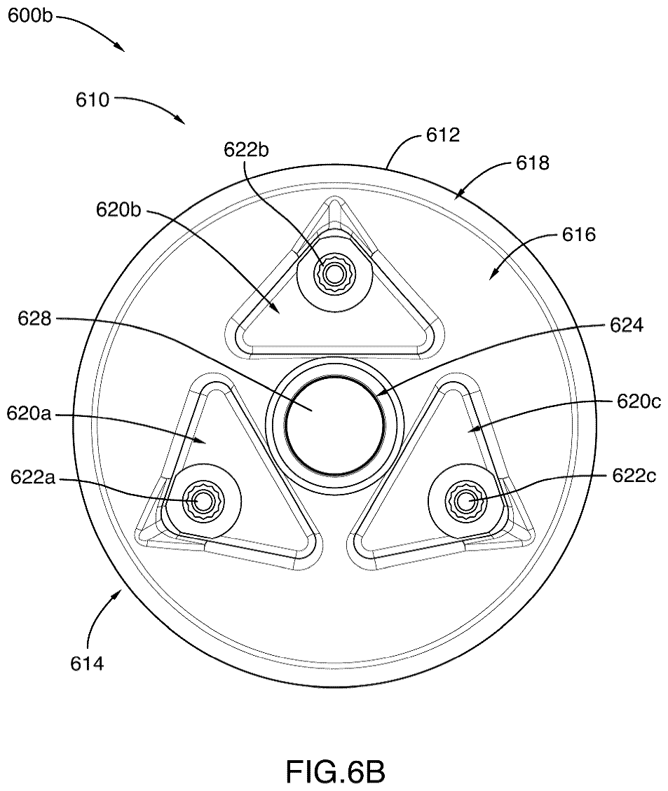

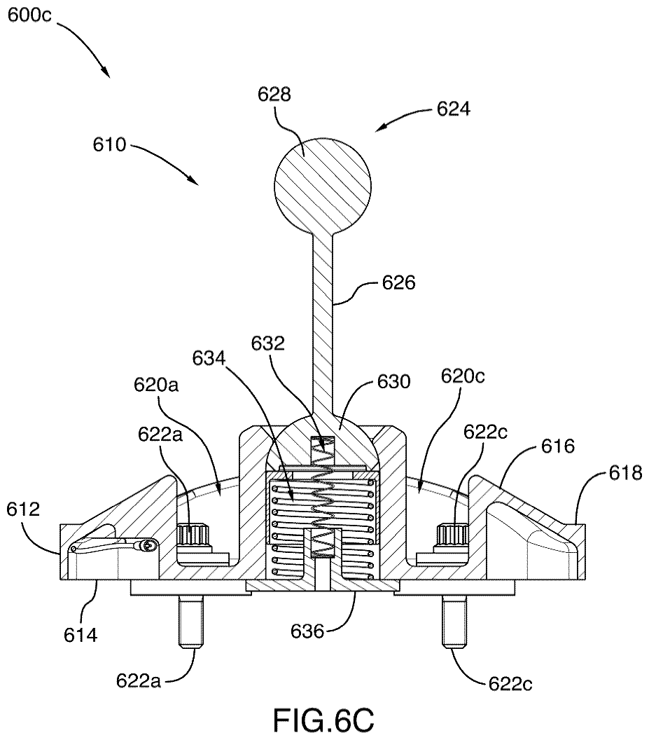

The free flyer object 304 includes a grapple fixture 312 mounted to an exterior surface of the free flyer object 304 for interfacing with the end effector 308, a berthing component 314 for berthing the free flyer object 304 through interfacing with the servicing mechanism 310, and an orbital replacement unit (ORU) 316 for transfer from the free flyer object 304 to the servicing satellite 302 via the end effector 308. The grapple fixture may be, for example, the grapple fixture of FIG. 2 or the grapple fixture of FIGS. 6A-6C.

Generally, the ORU 316 is a replaceable unit; that is, a unit for which there is a need to replace or move something. Examples of ORUs 316 include batteries, pumps, tanks, control moment gyroscopes, current switching units, containers and logistic carriers, robotic components (for replacement), radiators, plasma dischargers, antennas, power conditioners, and fluid couplers.

FIG. 3A illustrates the robotic arm 306 moving 318 from a parked position 320 to a “ready for free flyer capture” position 322. Both spacecraft 302 and 304 maintain attitude. The free flyer object 304 is shown having moved 305 from outside the capture box or ready-to-capture volume to within the capture box. Once the vision system sees the target, the system will initiate the free flyer capture sequence. Generally, the vision system may be configured to determine whether the free-flyer object 304 is within the capture box and is used from the robotic arm 306 to visually guide the robotic arm 306 such that the relative position and rate of the arm 306 with respect to the free-flyer object 304 establishes the free-flyer 304 in the capture box.

An arm vision system of the servicing satellite 302 confirms correct target tracking of the free flyer object 304. This may include tracking a machine vision target on the free flyer object 304. The machine vision target may be located near the grapple fixture 312.

Attitude control is disabled on both spacecraft 302, 304. In some scenarios, the client spacecraft may be put into “speed mode” wherein the reaction wheel runs at constant speed. This adds gyroscopic stiffness to the system which can improve soft capture probability without having the client attitude control system (ACS) fight the grapple. Generally, the system may be configured to avoid conditions where the spacecraft control bandwidths might fight the robotic capture.

FIG. 3B illustrates robotic arm 306 moving 326 from the ready for capture position to a capture position (non-deterministic location). The robotic arm 306 begins the capture sequence (soft capture to rigidization).

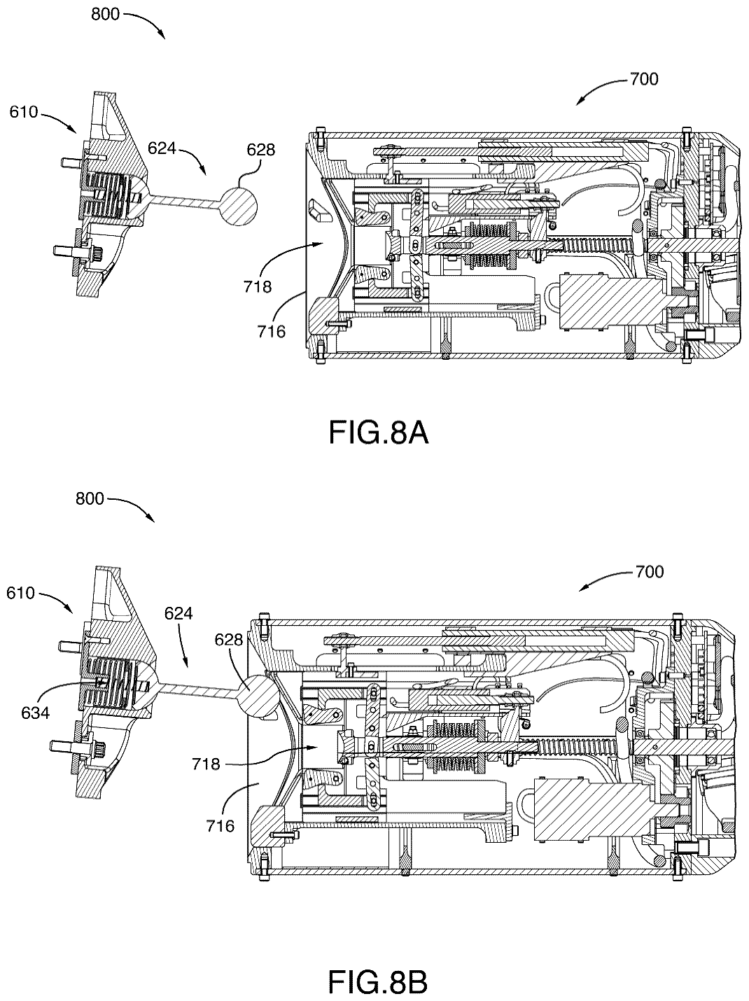

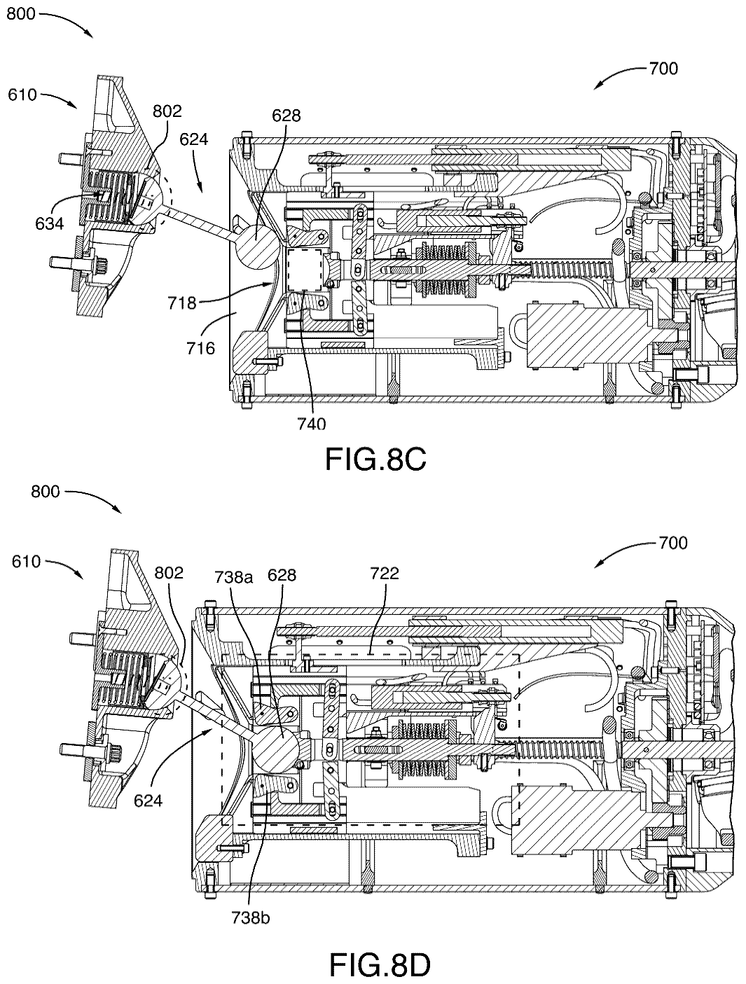

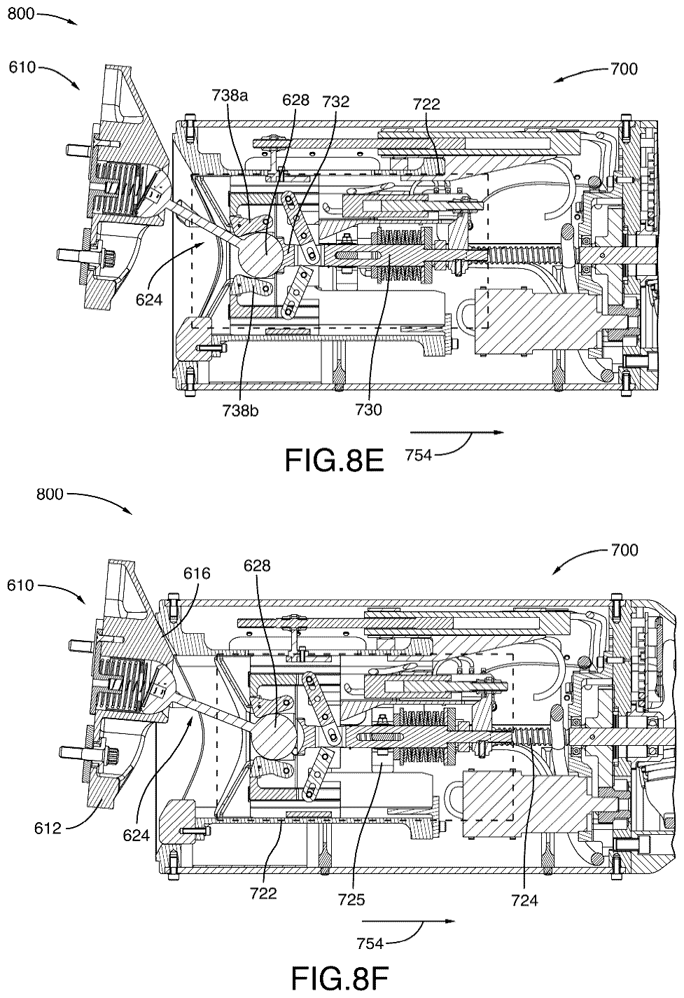

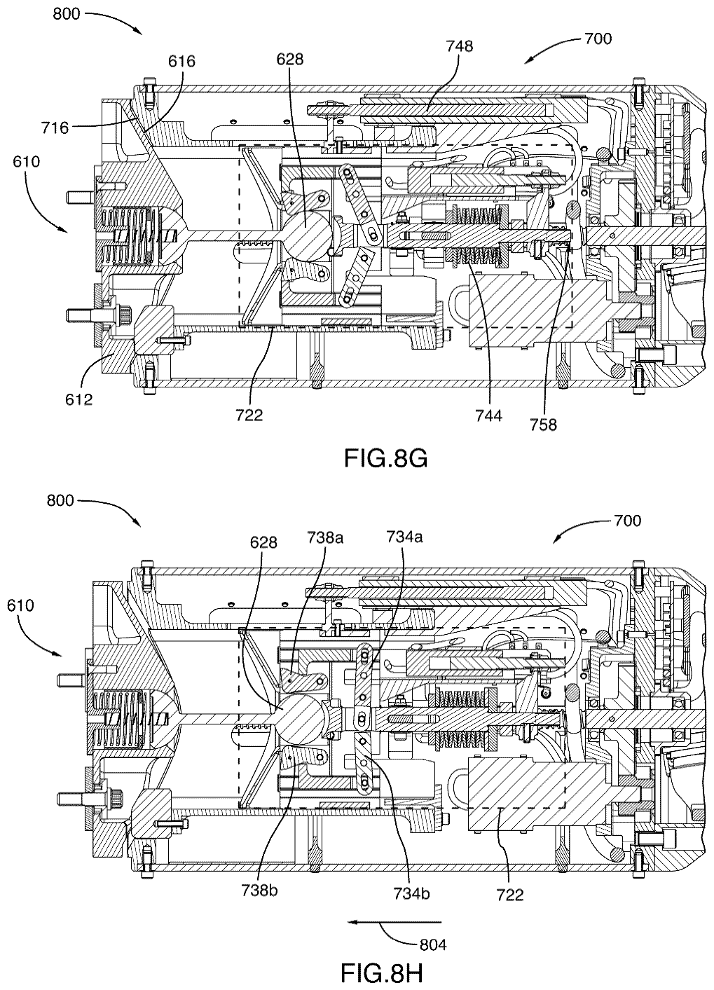

In doing so, the robotic arm 306 causes the end effector 308 to approach the grapple fixture 312 of the free flyer object 304 and perform capture (grapple and rigidize) of the free flyer object 304 via the grapple fixture 312. The capture sequence may be performed as described herein (e.g., FIGS. 7, 8).

The relative motion/velocity of the servicing satellite 302 and the free flyer object 304 is brought to ‘zero’.

FIG. 3C illustrates the robotic arm 306 bringing the captured free flyer object 304 from a capture position (in FIG. 3B) to pre-berth position and then further moving 328 the robotic arm 306 to a berthing position. The objective of this movement is to bring the berthing component 314 of the free flyer object 304 towards the servicing mechanism 310. The servicing mechanism 310 (docking connection) can perform other connectivity tasks that the capture system may not. The robotic arm 306 is limped when in the berthing position and the servicing mechanism 310 captures and berths the free flyer object 304 through the berthing component 314. “Limping” refers to reducing the loads on the joints of the robotic arm 306 to approximately zero so that the arm loads do not fight the berthing alignment.

Once berthed, the robotic arm 306 releases the grapple fixture 312 and returns to the parked position (not shown in FIG. 3C, parked position 320 shown in FIG. 3A). This enables the robotic arm 306 to perform other tasks while the servicing mechanism 310 holds the free flyer object 304.

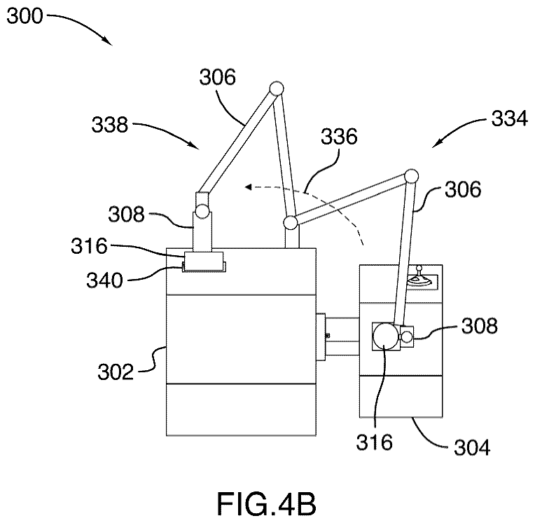

Referring now to FIGS. 4A-4B, shown therein is the free flyer capture system 300 of FIGS. 3A-3C performing an ORU transfer sequence after capture and berthing of the free flyer object 304 by the servicing satellite 302, according to an embodiment. While FIGS. 4A-4B show the ORU transfer sequence being performed by the same robotic arm (arm 306) as for the capture sequence in FIGS. 3A-3C, it is to be understood that the robotic arm may be the same or a separate manipulator depending on the embodiment (e.g., depending on the mission architecture in a space-based application). Similarly, the end effector 308 used in the ORU transfer sequence may be the same end effector as in the capture sequence or a different end effector (which may or may not be specially configured for the task). For example, in an embodiment, the end effector 308 used in the capture sequence may be a free flyer capture device tool that the arm 306 uses and puts away and the end effector 308 used in the ORU transfer sequence may be an end of arm tool changer configured for ORU pick and place. In another embodiment, the free flyer capture tool may be configured to also perform the ORU pick and place.

FIG. 4A illustrates the robotic arm 306 moving 330 from a parked position 332 to a high hover position (not shown) and then to a soft capture position 334. Movement to the soft capture position 334 results in non-rigid capture of the ORU 316. The arm end effector 308 then rigidizes its grasp on the ORU 316. The free flyer object 304 may be commanded to remove power from the ORU 316. The arm end effector 308 releases ORU latches to release the ORU 316 and the robotic arm 306 moves to the high hover position over the free flyer object 304 (not shown).

FIG. 4B illustrates movement 336 of the robotic arm 306 from the capture position 334 to a high hover position (not shown) over the servicing satellite 302 and then to an ORU insertion position 338. In doing so, the robotic arm 306 moves the ORU 316 from the free flyer object 304 to an ORU insertion location 340 on the servicing satellite 302. When in the ORU insertion position 340, the end effector 308 is commanded to engage the ORU latches (which were released in FIG. 4A when releasing the ORU 316 from the free flyer object 304) to connect the ORU 316 to the servicing satellite 302 at the ORU insertion location 340.

In some cases, at this stage, the servicing satellite 302 may apply power to the ORU 316. Certain embodiments may include a separate connector for power and/or data transfer. In some cases, power may be provided to the ORU 316 via the end effector 308 (e.g., via a separate electrical connection device on the end effector 308 to make the electrical connection). The ORU 316 may need power to survive while being transferred from one interface to another. Data connection to the ORU 316 permits the health and operating status of the ORU 316 to be monitored. In some cases, the robotic arm 306 may pick up the ORU 316 and use the ORU 316 to image or interact robotically with something. The ORU 316 typically needs power and a data connection to be used in this manner, which can be enabled through connection between the servicing satellite 302 and the ORU 316.

The robotic arm 306 may then command the end effector 308 to release the ORU 316 and the robotic arm 306 moves to parked position (as shown in parked position 332 of FIG. 4A).

Referring now to FIGS. 5A to 5C, shown therein are front perspective, front, and side views 500a, 500b, and 500c, respectively, of an end effector 510 for capturing a free flyer object, according to an embodiment.

The end effector 510 may be used to capture a free flyer object such as a client spacecraft having a grapple fixture mounted thereto. Generally, the end effector 510 is configured to capture the free flyer object by capturing and rigidizing the grapple fixture of the free flyer object.

The end effector 510 includes a receiving end 512 and a robotic arm interfacing end 514. The receiving end 512 is configured to interface with and capture a grapple fixture mounted to the free flyer object being captured. The robotic arm interfacing end 514 is configured to connect the end effector 510 to a robotic arm for manipulation of the end effector 510 via the robotic arm. Accordingly, the robotic arm interfacing end 514 may include various mechanical or electrical connections for facilitating the manipulation and operation of the end effector 510 via the robotic arm.

In some cases, the end effector 510 may include components enabling the end effector 510 to be engaged by another end effector. For example, the end effector 510 may include a grapple fixture mounted thereto for capturing the end effector 510 by the second end effector. The end effector 510 may also include one or more interfaces for passing power, data, or torque from the second end effector to the end effector 510.

The end effector 510 includes an outer housing 516. The outer housing 516 of end effector is generally cylindrical in shape. In other embodiments, the outer housing 516 may have any other suitable shape. The outer housing 516 may include any number of pieces or components. The outer housing 516 encloses an interior compartment (not shown) in which various components for the operation of the end effector, including for capture and rigidization of the free flyer grapple fixture, are disposed.

The end effector 510 also includes a stow/launch interface component 518 (shown only in FIG. 5B, its location is shown in FIGS. 5A, 5C). The stow/launch interface component 518 may comprise a docking port for putting the end effector 510 down in a known location (e.g., on a spacecraft). The known location may have access to power or umbilical connection with heaters through the stow/launch interface component 518.

The end effector 510 includes a front end component 520 mounted to the outer housing 516 at the receiving end 512 for interfacing with the grapple fixture of the free flyer object.

The front end component 520 includes a raised annulus 522 extending around the periphery of the front end component 520 for contacting a complementary annulus on the base of the grapple fixture (e.g., 618 as shown in FIGS. 6A-6C). The raised annulus 522 comprises a piece of material that is raised in profile relative to an outer annulus 524 of the front end component 520. The raised annulus 522 provides uniform distribution of clamping load and equal load-bearing capacity independent of applied pitch/yaw loads. In some embodiments, the raised annulus 522 may not be present.

The front end component 520 also includes a probe guiding surface 526. The probe guiding surface 526 is concave and includes an opening 528 for receiving a probe of a grapple fixture in order to position the probe in the capture mechanism. The opening 526 is positioned generally at the center of the probe guiding surface 526 (e.g., at a vertex of the concave surface). The probe guiding surface 526 is configured to passively guide the probe of the grapple fixture into the opening 528 upon the probe contacting the probe guiding surface 526. The system controlling the end effector 510 may be configured to cause the end effector 510 to approach the grapple fixture of the free flyer object at parameters (e.g., relative velocity, relative angle) known to promote successful guiding of the probe into the opening 528 via the probe guiding surface 526 (e.g., without having the probe bounce off the surface 526 due to such parameters). The management of such parameters by the control system of the end effector 510 may be particularly critical in free flyer object capture applications, where the potential for a misaligned grapple fixture to cause the free flyer object to bounce off the end effector 510 is more prevalent.

Features of the probe guiding surface 526, such as the material and angle of the surface, may be selected to achieve a desired interaction with the probe of the grapple fixture. For example, the features may be selected to achieve a desired level of friction or to more efficiently guide the contacting probe towards and into the opening 528.

The probe guiding surface 526 includes a concave insert 530. The concave insert 530 is moveable along a capture axis (e.g., capture axis 726 of FIG. 7A, below) as part of a capture mechanism in the interior compartment of the end effector 510. For example, the concave insert 530 may be the forward most (proximal to the receiving end 512) component of the capture mechanism. In FIGS. 5A and 5B, the concave insert 530 is in a full forward position and will retract along the capture axis towards the arm interfacing end 514during the capture sequence.

The concave insert 530 may be composed of the same material and have the same surface properties as the rest of the probe guiding surface 526. The concave insert 530 may simply be a continuation of the probe guiding surface 526 that is mounted to a section of the device that retracts to move from soft capture to hard capture (rigidize). In other embodiments, the probe guide surface 526 may be a single piece (i.e., where the surface is continuous rather than an outer surface plus the insert). However, using a single piece for the probe guiding surface 526 instead of the concave insert 530 may result in interference with the grapple probe as the grapple probe is drawn inwards to align the interfaces. As such, embodiments using the concave insert 530 may advantageously avoid such interference.

The front end component 520 also includes three protrusions or “fins” 532a, 532b, 532c (referred to collectively as fins 532 and generically as fin 532) mounted to the probe guiding surface 526.

The fins 532 act as alignment features that help align the receiving end of the end effector 512 with the grapple fixture of the free flyer object. The fins 532 are configured to mate with complementary alignment features (pockets 620 shown in FIGS. 6A-6C). For example, when capturing the grapple probe of the free flyer object, there may be some level of offset present attributable to the free flyer object having a tumble rate. The capture mechanism capturing and retracting the probe of the grapple fixture may provide coupling but may be translationally misaligned by an amount (e.g., a couple inches). The fins 532 enable the grapple fixture and front end component 520 to come together in alignment even where the free flyer object is rotationally misaligned by an amount. In such cases, the fins 532 are designed to slide down rounded edges of the respective pockets (triangle cutouts) of the grapple fixture base to sit inside the pockets. In doing so, the fins 532 (along with the pockets of the grapple fixture) give rotational and shear alignment of the grapple fixture and front end component 520 when bringing the two together. The fins 532 thus provide a mechanism for correcting rotational misalignment and for performing self-alignment. In an embodiment, the fins (and pockets) and configured to align a rotational offset of up to 5 degrees. In some embodiments, such as where the front end component 520 does not include the raised annulus 522, the interface may be grounded on the fins 532. In such embodiments, three fins 532 are used for determinism. In embodiments where the interface is grounded on the raised annulus 522, the number of fins 532 may vary. In such cases, a minimum of two fins 532 may be used on the front end component 520 for rotational alignment about the central axis.

The fins 532 have rounded surfaces enabling the fins 532 to travel down rounded edges of the complementary pockets. Fins 532 may be dry lubed. Lubrication may be selected based on suitability for the operational environment. The fins 532 may also have one or more round surfaces or angled corners to promote guiding or deflection of the ball of the grapple probe towards the opening 528 upon the probe contacting the fin 532.

Embodiments of the front end component 520 which include the raised annulus 522 for grounding the interface may provide particular advantages (e.g., over embodiments grounding the interface on the fins 532). Contacting at three points (such as in the case of grounding on the three fins 532) means that in certain directions the stance at which bending loads are reacted is quite small (centerline to the line between two fins), whereas the annulus 522 is always maximizing the stance to react the loads regardless of direction.

Referring now to FIGS. 6A to 6C, shown therein are front perspective, front, and side cross-sectional views 600a, 600b, 600c, respectively, of a grapple fixture 610 for mounting to a free flyer object (or other object to be captured) and for capture by and mating with the end effector 510 of FIGS. 5A to 5C, according to an embodiment.

The grapple fixture 610 includes a base 612.

The base 612 includes a mounting surface 614 for mounting the grapple fixture 610 to an external surface of the free flyer object (or other object, as the case may be).

The base 612 also includes a mating surface 616 opposing the mounting surface 614 for mating with or coupling to the probe guiding surface 526 of the end effector 510. The mating surface 616 is convex in shape. The curve of the mating surface 616 may be configured to match or substantially match the curve of the probe guiding surface 526 of the end effector 510, such that the two surfaces are complementary in shape.

The mating surface 616 of the base 612 includes a flat annular portion 618 extending around the periphery of the mating surface 616 for contacting and mating with the raised annulus 522 of the end effector 510 upon capture.

The mating surface 616 also includes recesses (or pockets or cutaway portions) 620a, 620b, 620c (referred to collectively as recesses 620 and generically as recess 620) for promoting alignment between the grapple fixture 610 and the front end component 520 of the end effector 510. In particular, the recesses 620 are positioned on the mating surface 616 and configured to receive respective fins 532 on the end effector 510. The recesses 620 are triangular. In other embodiments, the recesses 620 may be any other suitable shape. Triangular-shaped recesses or openings may advantageously reduce likelihood that fins 532 will contact the grapple fixture 610 prior to soft capture. The edges of the recesses 620 provide a guide towards the bottom of the fin alignment “V” shaped feature. This is provided by a triangular cut-out. The recesses 620 have a flat or non-flat bottom surface and curved or rounded side surfaces. The curved side surfaces promote sliding of the fin 532 to the bottom surface and into the desired position. In some embodiments, the fins 532 do not go to and contact the bottom surface (for example, in an annulus reaction embodiment in which the annulus is used to react loads at the interface and the fins 532 are not) but rather a clearance is left between the fin 532 and the bottom surface within an acceptable alignment variance. The clearance may be slight.

Each recess 620 includes a fastener 622 (fasteners 622a, 622b, 622c) therein passing from the bottom surface of the recess 620 through to the mounting surface 614. The fasteners 622 are used to mount the base 612 of the grapple fixture 610 to the free flyer object. The fasteners 622 may be buried out of the way so that the fasteners 622 do not interact with the fins 532. In an embodiment, the grapple fixture 610 may include isolation (thermal and electrical) under the fasteners 622 and also between the grapple fixture base 618 and the object to which the grapple fixture 610 is mounted (e.g., spacecraft).

The grapple fixture 610 also includes a deflectable probe 624 mounted to the base 612. The deflectable probe 624 includes a shaft 626, a spherical (or ball) shaped end 628 connected to a first end of the shaft 626, and a mounting end 630 connected to a second end of the shaft 626. In variations, the probe end 628 may have different shapes.

The deflectable probe 624 is connected to a deflection element for enabling the deflectable probe to deflect from a rest position in the direction of an applied force and return to the rest position when the force is removed (the probe 624 is shown in the rest position in FIGS. 6A to 6C). The rest position may be substantially perpendicular to the base 612. The deflection element includes one or more springs for enabling deflection. In the embodiment of FIG. 6C, the deflection element includes deflection spring 634 which returns the probe to center or rest position when deflected. In other embodiments, the deflection element used to make the probe 624 deflectable may be any suitable mechanical spring in compression, a pneumatic component (e.g., in marine applications), an actively tensioned component, a nullspring, or a flexible shaft (on shaft 626).

The deflectable probe 624 also includes a coaxial spring 632. The coaxial spring 632 is used for electrostatic shock conduction. The coaxial spring 632 electrically connects the probe 624 to the base 612 of the grapple fixture 610. The coaxial spring 632 permanently connects the probe 624 electrically to the base 612 of the grapple fixture 610. When the probe tip 628 contacts the conical interface on the end effector during capture (surface 526 of FIG. 5A), the coaxial spring 632 then electrically connects the servicer ground to the free flyer ground through a dissipative resistor. This enables charge to flow, but with greatly reduced current so as to limit damage. This approach is used as dry-lubrication in the ‘knuckle-joint’ of the probe 624 is likely to be insulating. The coaxial spring 632 may enable the capture system to be used in geosynchronous and other high orbits that have environmental conditions that lead to electrostatic charging of objects. For example, when two objects with different charge levels come into contact, large electrostatic discharge events can occur which can endanger avionics and power systems on either object (e.g., on the capture system side or the free flyer side).

The coaxial spring 632 connects to the deflectable probe 624 at the mounting end 630. The grapple fixture 610 further includes a spring mounting component 636. The spring mounting component 636 may include one or more pieces. The coaxial and deflection springs 632, 634 are attached to the spring mounting component 636 and the spring mounting component 636 is mounted to the base 612 via the mounting surface 614. The spring mounting component 636 may function as a spring retainer.

Referring now to FIGS. 7A to 7F, shown therein is a free flyer capture end effector 700 in various stages of operation while performing soft capture and hard capture of a free flyer object, according to an embodiment. The end effector 700 is shown in a cross-sectional side view. In FIGS. 7A to 7F, the free flyer object, including the grapple fixture mounted thereon, is not shown but is understood to be present during the operational sequence (where appropriate).

FIG. 7A shows the end effector 700 in a full forward position 702a. In the full forward position 702a, the end effector 700 is in a non-functional, resting state (e.g., in orbit).

Various components of the end effector 700 are labelled in FIG. 7A. In subsequent FIGS. 7B to 7F, only certain components performing functions at the particular stage depicted in the respective figure may be labelled to reduce clutter. It is to be understood that such unlabeled components may still perform functions and be referred to by their respective reference numerals.

The end effector 700 includes an outer housing 704 enclosing an interior compartment 706 in which various components are disposed for performing capture (soft capture and hard capture) of the grapple fixture.

The end effector 700 also includes an arm interface component 708 and a launch/stow interface 710 mounted to respective external surfaces of the outer housing 704. The arm interface component 708 is mounted at an arm interface end 712 of the end effector 700. The arm interface component 708 is an interface to the robotic arm and may provide a tool changer interface. The launch/stow interface 710 is a device enabling stowage of the end effector when not in use.

The end effector 700 includes a receiving end 714 opposite the arm interface end 712 for receiving and interfacing with the grapple fixture of the free flyer object.

Located at the receiving end 714 of the end effector 700 is a probe guiding surface 716. The probe guiding surface 716 may be mounted to the outer housing 704 at the receiving end 714. The probe guiding surface 716 includes an opening 718 therein for receiving a probe of the grapple fixture. The probe guiding surface 716 is designed and configured to guide the probe of the grapple fixture upon contact with the probe guiding surface towards and into the opening 718. Such contact and guiding of the probe may occur upon movement of the end effector 700, and in particular the receiving end 714 thereof, towards the grapple fixture of the free flyer object for capture. The probe guiding surface 716 is generally concave shaped. The shape or profile of the probe guiding surface 716 may be configured such that it is complementary to and mates with a base of the grapple fixture.

The end effector 700 further includes three fins 720 mounted to the probe guiding surface 716. Only two fins 720 are visible in FIG. 7A. In variations, the number and position of the fins 720 on the probe guiding surface 716 may vary. The fins 720 are configured to mate with complementary components on the base of the grapple fixture.

The end effector 700 includes a capture mechanism 722 (denoted by dashed line) disposed in the interior compartment 706 for capturing and rigidizing the grapple fixture. In the embodiment shown in FIGS. 7A to 7F, the capture mechanism 722 is a mousetrap mechanism. The capture mechanism 722 is mounted on first and second ball screws 724 (only one ball screw is visible in FIG. 7A). The capture mechanism 722 is moveable (linearly displaceable) along a capture axis 726 via the ball screws 724. For example, the capture mechanism 722 is retractable (that is, moveable along the capture axis away from the receiving end 714) when performing capture and moveable in the opposite direction along the capture axis towards the receiving end 714 when releasing the grapple fixture or preparing for capture. The capture mechanism 722 is connected to the ball screws 724 via ball nuts 725, the movement of which relative to the ball screws 724 cause displacement of the capture mechanism 722 along the capture axis 726.

The capture mechanism 722 includes a front end component 728 comprising a concave probe guiding surface and a central opening (opening 718). Generally, the probe guiding surface of the front end component 728 is configured to contact the probe of the grapple fixture and passively guide the probe into and towards and into the opening. The front end component 728, when the capture mechanism 722 is fully forward along the capture axis 726, forms part of the probe guiding surface 716. Generally, the front end component 728 comprises a conical insert which is part of the structure of the retracting capture mechanism 722. The mousetrap mechanism of the capture mechanism 722 is positioned close to the conical surface of the front end component 728. The front end component 728 moves with the mousetrap mechanism. In other embodiments, the front end component 728 may be part of the probe guiding surface 716 as one piece and not retract with the capture mechanism 722. Retracting the front end component 728 with the capture mechanism 722 may advantageously avoid an interference with the grapple shaft during retraction and alignment which may occur in embodiments where the front end component 728 does not retract with the capture mechanism 722.

In an embodiment, the capture mechanism includes one or more detent plungers for keeping the capture mechanism (mousetrap) in place during soft capture. The detent plungers are also configured to keep the capture mechanism in place during release so that the jaws open before a release state is indicated.

The capture mechanism 722 includes a plunger 730 disposed along the capture axis 726. The plunger 730 includes a probe contacting end 732. The plunger 730 is moveable (linearly displaceable) along the capture axis in both directions. Generally, upon the probe of a grapple fixture contacting (the end effector and grapple fixture moving towards one another) the probe contacting end 732, the plunger 730 is displaced along the capture axis 726 towards the arm interface end 712. The shape of the probe contacting end 732 may be shaped to ensure the grippers 738 surround the probe end of the grapple fixture (e.g., probe end 628).

The capture mechanism 722 further includes linkage arms 734a, 734b, gripper sliders 736a, 736b, and grippers 738a, 738b. The linkage arms 734a, 734b are attached at a first end to the plunger 730 and attached at a second end to the gripper sliders 736a, 736b, respectively. The gripper sliders 736a, 736b are configured to contact the grippers 738a, 738b, respectively. In particular, the gripper sliders 736a, 736b can move along the surface of the grippers 738a, 738b to move the grippers 738a, 738b between an open position and a closed position. The grippers 738a, 738b are configured to grip or grapple the probe of the grapple fixture when in the closed position and not contact the probe when in the open position (e.g., to facilitate entry of the probe into a soft capture position where the probe can be gripped, and release of the probe). Grippers 738 are held open by a spring prior to soft capture to permit the probe to enter the soft capture mechanism (mousetrap). Generally, the space between the opening 718, the probe contacting end 732 of the plunger 730, and the first and second grippers 738a, 738b defines a soft capture position 740 of the probe. In this sense, the probe guiding surface 716 is configured (along with the relative motion of the end effector and the free flyer object) to passively guide the probe of the grapple fixture through the opening 718 and into the soft capture position 740.

The capture mechanism 722 also includes a grapple housing 742. The grapple housing 742 encloses various components of the capture mechanism 722 involved in grappling the probe. The front end component 728 is mounted to the grapple housing 742 of the capture mechanism 722.

The capture mechanism 722 also includes a compressible element 744 for generating a predetermined preload to achieve hard capture of the grapple fixture. In the end effector 700 of FIGS. 7A to 7F, the compressible element 744 is a Belleville spring stack. The compressible element 744 is compressible along the capture axis 726 to generate the required preload.

The end effector 700 also includes first and second potentiometers 746, 748. The first and second potentiometers 746, 748 are linear potentiometers configured to measure overall position of the capture mechanism 722. The potentiometers 746, 748 are used to sense when certain states in the capture process have been achieved and to trigger subsequent actions.

The first potentiometer 746 is connected to the plunger 730 for measuring position of the plunger 730. In particular, the potentiometer 746 may include a shaft disposed in a body and connected to the plunger 730 such that when the plunger moves along the capture axis 726, the shaft moves similarly along the capture axis 722 and relative to the body.

The second potentiometer 748 is connected to the grapple housing 742 for measuring position of the capture mechanism 722 (via position of the grapple housing 742). In particular, the potentiometer 748 may include a shaft disposed in a body and connected to the grapple housing 742 such that when the capture mechanism 722 (including the grapple housing 742) is moved along the capture axis 726, the shaft moves similarly along the capture axis 726 and relative to the body.

The end effector 700 includes two limit switches 750 (only one is visible in FIG. 7A) disposed in the interior compartment 706. Two limit switches 750 provide reliability and redundancy. In other embodiments, a single limit switch 750 may be used. The limit switches 750 are configured to indicate that soft capture has occurred in an immediate, determinate, and binary fashion. Upon such indication by the limit switch 750, retraction to hard capture/rigidize may happen immediately.

The end effector 700 also includes a brake 752 disposed in the interior compartment 706. The brake 752 holds the mechanism in the rigidized preload state so that the motor drive in the end of arm can be powered off and the capture interface remains preloaded so that it can react loads.

Referring now to FIG. 7B, shown therein is the end effector 700 in an armed (ready for soft capture) state 702b. In the armed state 702b, the grippers 738a, 738b are open and the linkage arms 734a, 734b are in an over center position. “Over center position” refers to use in an over-center spring mechanism. The over-center spring mechanism may be used to mechanically hold a pivoting structure in selected resting positions relative to a pivot point. The over-center spring mechanism may include a tension spring that is attached at one end to a fixed structure and at the other end to the pivoting structure.

The arming of the capture mechanism 722 in FIG. 7B allows the plunger 730 room to move when the ball 628 of the grapple probe 624 contacts the front of the plunger 730 on capture approach. The linkage 734a, 734b snaps into jaws closed when the plunger 730 moves enough to bring the spring linkage 734a, 734b back over top-dead-center. Various components of the capture mechanism 722 may be dry lubricated using a suitable lubricant for the operational environment.

Referring now to FIG. 7C, shown therein is the end effector 700 in a tripped (or soft capture) state 702c.

In the tripped position 702c, the probe of the grapple fixture (not shown) has been received through the opening 718 in the probe guiding surface 716 and into the soft capture position 740. In particular, as the probe enters the soft capture position 740 an end of the grapple fixture probe contacts the probe contact end 732 of the plunger 730, displacing the plunger 730 along the capture axis 726 towards the arm interface end 712 corresponds to the grapple fixture (not shown) and soft capture having been initiated.

As the probe of the grapple fixture, having entered the soft capture position 740, contacts the probe contacting end 732 of the plunger 730, applying a force to the probe contacting end 732 in direction 754, the plunger is displaced along the capture axis 726 in direction 754.

Displacement of the plunger 730 in direction 754 causes displacement of the linkage arms 734a, 734b from the position shown in FIG. 7B to the position shown in FIG. 7C. Displacement of the linkage arms 734a, 734b causes the gripper sliders 736a, 736b, previously holding the grippers 738a, 738b in the open position, to slide along the grippers 738a, 738b, causing the grippers to move into the closed position, thereby grabbing the probe.

As the plunger 730 is displaced in direction 754, so too is the shaft of the first potentiometer 746 in direction 754. Telemetry of 746 can assist in determining soft capture state or anomalous state.

At this stage, the end of the grapple fixture probe (e.g., a spherical end thereof) having entered the capture mechanism is grappled or grabbed by the capture mechanism (via grippers 738a, 738b).

For example, the probe end contacting the plunger 730 may cause springs attached to the linkage arms 734 to shut the mousetrap and, once pushed far enough, closing the grippers 738 around the ball tip of the probe.

Referring now to FIG. 7D, shown therein is the end effector 700 in a begin retraction state 702d. Retraction is initiated in response to the limit switch 750 indicating that the capture device 722 has changed state from jaws open to jaws closed. This occurs when the probe ball 628 has entered the capture mechanism 722 and caused the capture mechanism 722 to snap over (i.e., like a mousetrap).

In position 702d, a ball screw actuator (not shown) rotates the ball screw 724, causing the ball nut 725 to translate in direction 754. The ball nut 725 is attached to the plunger 730 through a slot 756 in the plunger 730. In the case of FIG. 7D, the ball nut 725 has moved in direction 754 from a first end of the slot 756 proximal to the receiving end 714 to a second end of the slot 756 proximal to the arm interface end 712. When in the position shown in FIG. 7D, the ball nut 725, if further translated in direction 754 via rotation of the ball screw 724, will translate the plunger 730 in direction 754 and thus retract the capture mechanism 722.

Referring now to FIG. 7E, shown therein is the end effector 700 in a grapple fixture seated state 702e. In the grapple fixture seated position 700e, the capture mechanism 722 (which has grappled or grabbed the probe of the grapple fixture) has been fully retracted in direction 754 along the capture axis 726 to a seated position 758. The retraction of the capture mechanism 722 is achieved via further rotation of the ball screws 724 (as in FIG. 7D) which causes the ball nut 725 to translate the capture mechanism 722 (via the connection to the plunger 730 through the slot 756) in direction 754 to the seated position 758.

As the capture mechanism 722 is translated in direction 754, the shaft of the second potentiometer 748, which is connected to the capture mechanism 722 via connection to the grapple housing 742, is similarly translated (in the body of the potentiometer 748), which causes a state change in the potentiometer 748. The state change (to tripped) in the potentiometer 748 is detected, indicating soft capture of the grapple fixture has been made and it is time rigidize the grapple fixture. The potentiometer 748 itself does not detect the state change after soft capture. Potentiometer 748 does not move during soft capture.

Referring now to FIG. 7F, shown therein is the end effector 700 in a hard capture or rigidized state 702f. In the hard capture state 702f, the grapple fixture is rigidized to the end effector 700. In particular, the base of the grapple fixture has been rigidized to the receiving end of the end effector 700.

To rigidize the interface between the grapple fixture and end effector 700, the Belleville stack 744 is compressed to achieve a desired load. Compression of the Belleville stack 744 is achieved via movement of the ball nut 725 in direction 754. The load corresponds to how far the grapple fixture should be retracted to get the desired load. More specifically, the load increase begins after the grapple fixture is seated and the load corresponds to how far the ball screws are driven. The load may be predetermined. For example, in the case of a space-based application, the load may be determined on ground.

In particular, a bar 760 of the plunger 730 disposed in the plunger slot 756 between the ball nuts 725 pushes on the spring stack 744. Once the capture (mousetrap) mechanism 722 cannot move axially due to the length of the grapple probe 624 then continued motion of the ball nuts 725 compress the spring stack 744. This compression of the spring stack 744 puts preload on the annular interface between the probe guiding surface 716 of the end effector 700 and the grapple fixture 610. So, bar 760 is moving in slot 756 and moving with the ball nut 725 to compress the spring stack 744, now that capture mechanism 722 is fully retracted.

In variations, other spring elements may be used in place of the Belleville stack 744. However, disc springs, or Belleville springs, may be particularly advantageous as they are a compact way to generate large loads in a small volume with a relatively small deflection.

Once the grapple fixture is rigidized, power may be taken off of the brake 752 to drop closed and hold the free flyer object in the loaded position. Power may be cut to a drive motor (used to drive motion of the capture mechanism 722) to not lose power continuously while holding onto the rigidized payload. This can be advantageous in situations where the end effector 700 may be holding onto the free flyer object (e.g., client spacecraft) for an extended period of time (e.g., hours).

Referring now to FIGS. 8A to 8H, shown therein is a system 800 for robotic capture of a free flyer object in various stages of capture according to an embodiment. The system 800 includes the end effector 700 of FIGS. 7A to 7F and the grapple fixture 610 of FIGS. 6A to 6C. The end effector 700 is attached to an end of a robotic arm and the grapple fixture 610 is mounted to an external surface of the free flyer object. For simplicity, the robotic arm and free flyer object have been omitted.

Referring now to FIG. 8A, shown therein is the end effector 700 approaching the grapple fixture 610 as part of a capture approach. The grapple fixture 610 is misaligned. The grapple ball 628 of the deflectable probe is both laterally and angularly offset from the center (opening) of the front end component. In an embodiment, the end effector 700 may be configured to capture a grapple ball 628 that is laterally offset from the center 718 of the probe guiding surface 716 by a maximum of 30 mm and angularly offset by a maximum of 5 degrees about the ball 628 and also 5 degrees in roll.

The capture mechanism 722 of the end effector 700 is in an armed state (as in 702b in FIG. 7B).

Referring now to FIG. 8B, shown therein is initial contact between the deflectable probe 624 and the probe guiding surface 716. The grapple ball 628 of the deflectable probe 624 contacts the probe guiding surface 716 and a shaft centering spring 634 of the grapple fixture 610 cushions the initial impact of the deflectable probe 624. The probe guiding surface 716 begins to passively guide the grapple ball 628 towards the opening 718 and the capture mechanism 722.

Referring now to FIG. 8C, shown therein is deflection 802 of the deflectable probe 624 about the deflectable joint prior to the grapple ball 628 entering the opening 718 and into the soft capture position 740. The deflectable probe 624 is deflecting as the end effector 700 continues to move towards the free flyer object. The deflection 802 allows the grapple ball 628 (spherical tip) of the deflectable probe 624 to reach the soft capture position 740 without requiring movement of the free flyer object itself (although the free-flyer is not constrained and is free to move (and will move)).

Referring now to FIG. 8D, shown therein is the deflectable probe 624 entering the capture mechanism 722 of the end effector 700. The deflectable probe 624, via deflection 802, has reached the soft capture position 740 without needing a change in orientation of the base 612 of the grapple fixture 610 (and thus without needing a change in orientation of the free flyer object to which the base 612 is mounted). This can be seen by the constant orientation of the base 612 throughout FIGS. 8A to 8D.

As can be seen, the grippers 738a, 738b of the capture mechanism 722 are in the open position, enabling the grapple ball 628 to enter the soft capture position 740 between the grippers 738.

Referring now to FIG. 8E, shown therein is initiation of soft capture of the grapple fixture 610 by grappling the grapple ball 628. The grapple ball 628 of the deflectable probe 624 triggers the capture mechanism 722 to achieve soft capture by contacting the probe contacting end 732 and displacing the plunger 730 along the capture axis 726. Displacement of the plunger 730 in direction 754 causes the grippers 738 to move from the open position to the closed position (as described in FIG. 7C), thereby grappling the grapple ball 628 of the deflectable probe 624.

Soft capture of the grapple fixture 610 constrains three degrees of freedom (linear motion) of the grapple fixture 610. Three degrees of freedom (angular motion) of the grapple fixture 610 remain free. Soft capture grapples the grapple ball 628 such that the grapple ball 628 is held in translation but not restrained in rotation.

Referring now to FIG. 8F, shown therein is the capture mechanism 722 of the end effector 700 beginning to retract towards a hard capture position.

As can be seen, retraction of the capture mechanism 722, which has grappled the deflectable probe 624, brings the base 612 of the grapple fixture 610, and in particular the mating surface 616, towards the probe guiding surface 716 of the end effector 700 for mating.

Translation of the capture mechanism 722 in direction 754 is effected by translation of the ball nuts 725 (which are connected to the capture mechanism 722) in direction 754 via rotation of the ball screws 724.

During retraction, the angular and lateral offsets of the free flyer object relative to the end effector 700 are removed. Angular and lateral offsets are removed by bringing the conical features of the probe guiding surface 716 of the end effector 700 and the mating surface 616 of the grapple fixture 610 together, along with the fins 532 and v-grooves 620, which forces the two sides of the interface into alignment as the gap between the two sides of the interface is closed.

Referring now to FIG. 8G, shown therein is hard capture of the grapple fixture 610 by the end effector 700 (rigidization of the interface).

Hard capture of the grapple fixture 610 is achieved when the capture mechanism 722 is retracted to the point where the grapple fixture 610 is preloaded up against the alignment features on the front (probe guiding surface 716) of the end effector 700 (reflected by hard capture position 758). This includes mating alignment features present on the mating surface 616 of the base 612 of the grapple fixture 610 with alignment features present on the probe guiding surface 716 of the end effector 700 (e.g., pins and recesses, annuli). The end effector 700 recognizes the capture mechanism 722 has reached the hard capture position 758 via a load sensor disposed behind the spring stack 744. The load sensor determines the position that provides the target preload. An indication from the load sensor when the target position is reached is generated and used to stop retraction. Accumulated drive shaft turns from a home position may be used to determine proper position in a calibration of the end effector 700.

Hard capture also includes compressing Belleville stack 744 as in FIG. 7F.

Once the interface between the grapple fixture 610 and the end effector 700 is rigidized through hard capture, the free flyer object can be manipulated by the end effector 700 and robotic arm attached to the end effector 700.

Referring now to FIG. 8H, shown therein is release of the captured grapple fixture 610.

To release the grapple fixture 610, the drive is driven (in direction 804) forward far enough to reset the linkages 734a, 734b of the capture mechanism 722 and drive the grippers 738a, 738b into the open position. In this embodiment, the PCT drive is the tool drive on the arm that enacts motion in the PCT through a torque shaft interface in the robotic arm interface. Doing so releases the grip on the grapple ball 628 of the deflectable probe 624. Initiation of release may depend on system architecture. Release may be initiated via sensors outside of the end effector 700. Release may resemble the end effector 700 moving from the configuration shown in FIG. 7c to the configuration shown in FIG. 7B.

While the above description provides examples of one or more apparatus, methods, or systems, it will be appreciated that other apparatus, methods, or systems may be within the scope of the claims as interpreted by one of skill in the art.

1-23. (canceled)

24. A system for robotic capture of a free flyer object, the system comprising:
a grapple fixture for mounting to the free flyer object and an end effector for interfacing with the grapple fixture to capture the free flyer object;
the grapple fixture comprising:
a base having a mounting surface for mounting to the free flyer object and a mating surface opposing the mounting surface for mating with the end effector; and
a deflectable probe connected to the base via a deflectable joint for enabling deflection of the deflectable probe, the deflectable probe including a probe tip for grappling;
the end effector, comprising:
an interface for connecting to and enabling manipulation by a robotic arm or a spacecraft with direct capture enablement capability;
a probe guiding surface for one or more of deflecting and guiding the probe tip of the deflectable probe towards and through an opening in the probe guiding surface and into a grappling position as the end effector is moved towards the grapple fixture and the grapple fixture is within a capture envelope of the end effector;
a probe sensing element for sensing when the probe tip is in the grappling position and triggering a capture mechanism upon sensing the probe tip in the grappling position;
the capture mechanism, the capture mechanism configured to grapple the probe tip when triggered by presence of the probe tip, the grappling of the probe tip creating a connection that constrains separation of the grapple fixture from the end effector (“soft capture”); and
an actuator configured to retract the capture mechanism along a capture axis to a predetermined position at which the mating surface of the base of the grapple fixture is preloaded against the probe guiding surface to establish a load-bearing interface between the free flyer object and the end effector (“hard capture”).

25. The system of claim 24, further comprising the robotic arm and a robotic arm controller for controlling the robotic arm, wherein the robotic arm controller is configured to command the robotic arm to move the end effector towards the grapple fixture upon approach such that the relative velocity of the end effector and the free flyer object is maintained within a predetermined velocity band known to promote successful soft capture.

26. The system of claim 24, wherein the mating surface of the grapple fixture includes a first alignment component and the probe guiding surface includes a second alignment component, wherein the first and second alignment components are configured to mate with each other for aligning the connection between the grapple fixture and the probe guiding surface of the end effector.

27. The system of claim 26, wherein the second alignment component is a raised annulus and the first alignment component is a recessed annulus.

28. The system of claim 26, wherein the first alignment component comprises a plurality of recesses in the mating surface and the second alignment component comprises a plurality of protrusions, wherein each respective one of the plurality of protrusions is configured to mate with a respective one of the plurality of recesses.

29. The system of claim 24, wherein the capture mechanism constrains linear motion of the free flyer object via the grappling of the probe tip and removes angular and lateral offsets of the free flyer object relative to the end effector by retracting the capture mechanism and bringing the mating surface of the grapple fixture into mate with the probe guiding surface on the end effector.

30. The system of claim 24, wherein the deflectable joint is a spring-centered spherical joint.

31. An end effector for performing robotic capture of a free flyer object having a grapple fixture mounted thereon, the end effector comprising:
a probe guiding surface for guiding a probe of the grapple fixture into a grappling position;
a capture mechanism for grappling a probe tip of the probe when the probe is in the grappling position, the grappling constraining the separation of the grapple fixture and the end effector; and
a hard capture mechanism for constraining the angular motion of the probe by retracting the grappled probe until the grapple fixture is preloaded against the probe guiding surface to establish a load-bearing interface between the free flyer object and the end effector.

32. The end effector of claim 31 further comprising:
a robotic arm interface for connecting to and enabling manipulation of the robotic end effector by a robotic arm or a spacecraft into the grappling position;
a probe sensing element for sensing when the probe is in the grappling position and triggering the capture mechanism upon sensing the probe in the grappling position wherein the capture mechanism is configured to grapple the probe tip when triggered by the probe sensing element; and
wherein guiding the probe into the grappling position further comprises one or more of deflecting and guiding a probe tip of the probe towards and through an opening in the probe guiding surface and into a grappling position as the end effector is moved towards the grapple fixture and the grapple fixture is within a capture envelope of the end effector, and
wherein the hard capture mechanism comprises an actuator configured to retract the capture mechanism along a capture axis when the probe is grappled to a first predetermined position at which a mating surface of a base of the grapple fixture is preloaded against the probe guiding surface to establish the load-bearing interface between the free flyer object and the end effector.

33. The end effector of claim 32, wherein the mating surface of the grapple fixture includes a first alignment component and the probe guiding surface includes a second alignment component, wherein the first and second alignment components are configured to mate with each other for aligning the connection between the grapple fixture and the probe guiding surface of the end effector.

34. The end effector of claim 33, wherein the second alignment component further comprises a plurality of protrusions disposed on the probe guiding surface for, during capture, mating with complementary recesses of the first alignment component disposed on the mating surface of the grapple fixture to align the connection between the grapple fixture and the probe guiding surface of the end effector.

35. The end effector of claim 34, wherein each respective one of the plurality of protrusions include a rounded surface to promote sliding of the protrusion along a side alignment surface of a respective one of the complementary recesses and further into the respective complementary recess.

36. The end effector of claim 33, wherein the probe guiding surface includes a raised annulus of the second alignment component for mating to a complementary recessed annulus of the first alignment component on the mating surface of the grapple fixture.

37. The end effector of claim 32, wherein the hard capture mechanism includes a spring-based compliant member, and wherein the actuator is configured to further retract the capture mechanism to compress the spring-based compliant member to provide the preload to the interface between the grapple fixture and the end effector.

38. The end effector of claim 31, wherein the capture mechanism includes a pair of jaws connected to the probe sensing element and configured to move from an open position to a closed position to grapple the probe tip when the grapple probe tip triggers the capture mechanism to close.

39. The end effector of claim 32, wherein the capture mechanism includes a concave insert component which forms part of the probe guiding surface including the opening when the capture mechanism is positioned fully forward along the capture axis and which is retracted with the capture mechanism during retraction.

40. A method of robotic capture of a free flyer object, the method comprising:
moving an end effector towards a grapple fixture on the free flyer object such that the grapple fixture is within a capture envelope of the end effector;
guiding a deflectable probe of the grapple fixture towards and through an opening in the probe guiding surface into a grappling position via a probe guiding surface of the end effector;
sensing the deflectable probe is in the grappling position and triggering a grappling mechanism;
grappling the deflectable probe with the grappling mechanism to constrain motion of the free flyer object in a least one degree of freedom upon sensing the deflectable probe is in the grappling position;
retracting the grappled deflectable probe along a capture axis to a predetermined position to remove angular and lateral offsets of the free flyer object relative to the end effector and to bring a mating surface of the grapple fixture into contact with the probe guiding surface; and
rigidizing the interface between the grapple fixture and the end effector by retracting the grappling mechanism to a point at which the grapple fixture is preloaded against alignment features on the probe guiding surface.

41. The method of claim 40, wherein guiding the deflectable probe further comprises:
contacting the deflectable probe with the probe guiding surface; and
deflecting the deflectable probe towards the opening with the probe guiding surface by continuing to move the end effector towards the free flyer object.

42. The method of claim 40, wherein moving the end effector towards the grapple fixture further comprises detecting a machine vision target on the free flyer object via a machine vision system and tracking the machine vision target with the machine vision system as the robotic arm moves the end effector towards the grapple fixture.

43. The method of claim 40, wherein moving the end effector towards the grapple fixture on the free flyer object is via a robotic arm and includes maintaining via a robotic arm controller a relative approach velocity including one or more of an approach speed and trajectory of the end effector and free flyer object within a predetermined velocity band known to promote successful soft capture of the grappled fixture.
